(19) United States
(12) Patent Application Publication
(10) Pub. No.: US 2022/0391801 A1
(43) Pub. Date: Dec. 8, 2022

(54) COMPOSITE WORKER RANKING

(71) Applicant: Optin, Inc., Danville, CA (US)

(72) Inventors: Wolfgang Kober, Foxfield, CO (US); David Walter Ash, Pleasant Hill, CA (US); Gopalakrishnan Hariharan, Highlands Ranch, CO (US)

(21) Appl. No.: 17/834,645

(22) Filed: Jun. 7, 2022

Related U.S. Application Data
(60) Provisional application No. 63/208,363, filed on Jun. 8, 2021.
(60) Provisional application No. 63/217,661, filed on Jul. 1, 2021.

(51) Int. Cl. G06Q 10/06

(52) U.S. Cl. CPC G06Q 10/06311; G06Q 10/06398

(57) ABSTRACT

Methods, systems, and devices for worker ranking, worker scheduling, and enterprise labor sharing are described. A method includes: receiving objective evaluation data associated with members of a workforce; receiving subjective evaluation data associated with the members; generating composite evaluation data associated with the first members based on the objective evaluation data, the subjective evaluation data, or both; and generating scheduling information associated with the members based on the composite evaluation data. Another method includes: assigning members of a workforce to candidate temporal periods of a work schedule, where the assigning is based on a priority order corresponding to composite evaluation data associated with the members. Another method includes: identifying a work task associated with a first member of a network; selecting a worker associated with a second member of the network based on the work task or worker data; and outputting a notification at a device associated with the worker.

### CROSS-REFERENCE TO RELATED APPLICATIONS

The present application claims the benefit of and priority, under 35 U.S.C. § 119(e), to U.S. Provisional Application Ser. No. 63/208,363 filed Jun. 8, 2021, entitled “Enterprise Platform,” and U.S. Provisional Application Ser. No. 63/217,661 filed Jul. 1, 2021, entitled “Enterprise Platform,” the entire disclosures of which are hereby incorporated herein by reference, in their entirety, for all that the disclosures teach and for all purposes.

### FIELD OF TECHNOLOGY

The following relates to enterprise platforms, including a platform and database supportive of ranking, scheduling, and labor sharing associated with members of one or more workforces.

### BACKGROUND

Some systems may support aspects of member resource management. For example, some systems may support applications associated with evaluating and scheduling members (e.g., employees, contract workers, managers, service providers) of a workforce. Techniques supportive of increased efficiency with respect to managing the members (e.g., member evaluations, member scheduling) are desired.

### SUMMARY

The described techniques relate to improved methods, systems, devices, and apparatuses that support an enterprise platform for worker ranking, worker scheduling, and labor sharing. Generally, the aspects of the present disclosure relate to a platform supportive of employer driven and/or employee driven Human Capital Management (HCM) techniques.

Methods, systems, devices, and apparatuses are provided that include: receiving objective evaluation data associated with a set of first members of a workforce; receiving subjective evaluation data associated with the set of first members; and generating composite evaluation data associated with the set of first members based on the objective evaluation data, the subjective evaluation data, or both. In some aspects, the composite evaluation data includes ranking information associated with at least one member of the set of first members. In some examples, the method includes generating scheduling information associated with at least one member of the first set of members based on the composite evaluation data, where the scheduling information includes one or more time-slots, one or more work tasks associated with the one or more time-slots, or both.

Other methods, systems, devices, and apparatuses are provided that include: generating first scheduling information associated with a work schedule, the first scheduling information including a first set of candidate temporal periods; receiving composite evaluation data associated with a set of members of a workforce, the composite evaluation data including ranking information associated with the set of members; assigning one or more members of the set of members to one or more candidate temporal periods of the first set of candidate temporal periods; and outputting second scheduling information based on the assigning. In some aspects, the assigning may be based on a priority order corresponding to the ranking information and the set of members.

Other methods, systems, devices, and apparatuses are provided that include: identifying a work task associated with a first member of a network; selecting a worker from among a set of workers associated with a second member of the network; and outputting a notification at a device associated with the worker. In some aspects, selecting the worker may be based on one or more parameters associated with the work task, worker data associated with the worker, or both. In some other aspects, the notification may include an indication of the work task, one or more parameters associated with the work task, identification information associated with the first member, or a combination thereof.

It is to be appreciated that any feature described herein can be claimed in combination with any other feature(s) as described herein, regardless of whether the features come from the same described implementation.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, implementations, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, implementations, and configurations of the disclosure are possible utilizing, alone or in combination, one or more of the features set forth above or described in detail below.

Numerous additional features and advantages of the present disclosure will become apparent to those skilled in the art upon consideration of the implementation descriptions provided hereinbelow.

### BRIEF DESCRIPTION OF THE DRAWINGS

FIG. 1 illustrates an example of a system that supports an enterprise platform for worker ranking, worker scheduling, and labor sharing in accordance with aspects of the present disclosure.

FIG. 2 illustrates an example of a system that supports an enterprise platform for worker ranking, worker scheduling, and labor sharing in accordance with aspects of the present disclosure.

FIG. 3 illustrates an example of a system that supports an enterprise platform for worker ranking, worker scheduling, and labor sharing in accordance with aspects of the present disclosure.

FIG. 4 illustrates an example of a process flow that supports worker (e.g., employee, manager, contractor) ranking in accordance with aspects of the present disclosure.

FIG. 5 illustrates an example of a process flow that supports worker scheduling and worker assignments in accordance with aspects of the present disclosure.

FIG. 6 illustrates an example process flow that support worker scheduling (e.g., dynamic and iterative scheduling of workers) in accordance with aspects of the present disclosure.

FIG. 7 illustrates an example of a process flow that supports member scheduling in accordance with aspects of the present disclosure.

FIG. 8 illustrates an example of a process flow that supports worker ranking in accordance with aspects of the present disclosure.

FIG. 9 illustrates an example of a process flow that supports worker scheduling in accordance with aspects of the present disclosure.

FIG. 10 illustrates an example of a labor sharing platform that supports worker ranking, worker scheduling, and labor sharing in accordance with aspects of the present disclosure.

FIGS. 11 through 16 illustrate example user interfaces that support an enterprise platform in accordance with aspects of the present disclosure.

FIG. 17 illustrates an example of a process flow that supports labor sharing in accordance with aspects of the present disclosure.

FIG. 18 illustrates an example of a system that supports an enterprise platform for worker ranking, worker scheduling, and labor sharing in accordance with aspects of the present disclosure.

### DETAILED DESCRIPTION

The disclosure and the various features and advantageous details thereof are explained more fully with reference to the non-limiting embodiments and examples that are described and/or illustrated in the accompanying drawings and detailed in the following. It should be noted that the features illustrated in the drawings are not necessarily drawn to scale, and features of one embodiment or example may be employed with other embodiments or examples as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

### Overview

Human capital management (HCM) includes a set of practices associated with resource management. In some cases, the practices may be implemented in categories such as workforce acquisition, workforce management, and workforce optimization. For example, HCM may be applied to applications such as core administrative support (e.g., personnel administration, payroll services, portal/employee self-service, etc.), strategic HCM support (e.g., workforce planning, competency management, performance management, compensation planning, time and expense management, training, recruitment, contingent workforce management, etc.), and other HCM support (e.g., workforce sharing, workforce reporting and analytics, workflow, etc.).

In some aspects, HCM may support company (e.g., enterprise, employer) monitoring and management of various workforces. Example aspects of the present disclosure may support HCM techniques for monitoring, evaluating, scheduling, and managing members (e.g., workers, employees, managers) of one or more workforces based on parameters such as associated skillsets, objective performance metrics, and subjective performance metrics.

Accordingly, for example, aspects of the present disclosure may support workforce management in association with human capital. Human capital may be defined as the collective stock of skills, attributes, knowledge, expertise of members of a workforce. The techniques described herein may support advantages such as increased productivity, increased profitability, and increased workforce management among one or more organizations.

Aspects of the disclosure are initially described in the context of a platform, system, and database supportive of employee ranking, employee scheduling, and labor sharing. Examples of processes and signaling exchanges that support an enterprise platform for worker ranking, worker scheduling, and labor sharing are then described. Aspects of the disclosure are further illustrated by and described with reference to apparatus diagrams, system diagrams, and flowcharts that relate to an enterprise platform for worker ranking, worker scheduling, and labor sharing.

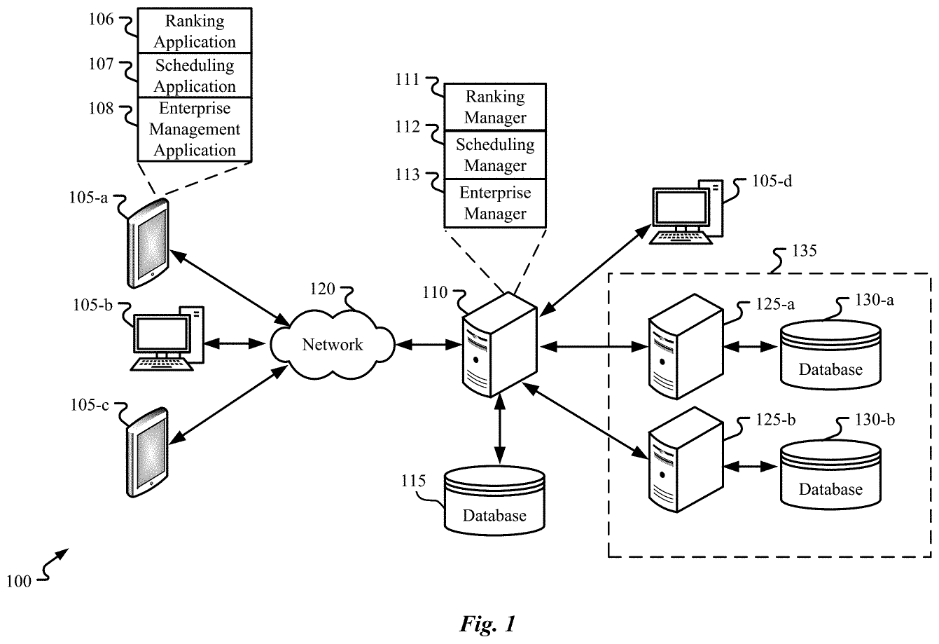

FIG. 1 illustrates an example of a system 100 that supports an enterprise platform for worker ranking, worker scheduling, and labor sharing in accordance with aspects of the present disclosure.

The system 100 may include communication devices 105 (e.g., communication device 105-a through communication device 105-d), a server 110, a database 115, a communication network 120, servers 125, and databases 130. The communication network 120 may facilitate machine-to-machine communications between any of the communication device 105 (or multiple communication devices 105), the server 110, one or more databases (e.g., database 115), and the servers 125. The communication network 120 may include any type of known communication medium or collection of communication media and may use any type of protocols to transport messages between endpoints.

The communication network 120 may include wired communications technologies, wireless communications technologies, or any combination thereof. In an example, the communication devices 105, the server 110, and the servers 125 may support communications over the communications network 120 between multiple entities (e.g., members, employees, contract workers, managers, enterprises). In some cases, the system 100 may include any number of communication devices 105, and each of the communication devices 105 may be associated with a respective entity (e.g., member, employee, contract worker, manager, enterprise). In some cases, the system 100 may include any number of servers (e.g., servers 110 and/or servers 125), each associated with a respective entity (e.g., enterprise, organization).

A communication device 105 may transmit or receive data packets to one or more other devices (e.g., another communication device 105, a server 125) via the communication network 120 and/or via the server 110. For example, the communication device 105-a may communicate (e.g., exchange data packets) with the communication device 105-b via the communications network 120. In another example, the communication device 105-a may communicate with another device (e.g., communication device 105-d, database 115, a server 125) via the communications network 120 and the server 110.

Non-limiting examples of the communication devices 105 may include, for example, personal computing devices or mobile computing devices (e.g., laptop computers, mobile phones, smart phones, smart devices, wearable devices, tablets, etc.). In some examples, the communication devices 105 may be operable by or carried by a human user. In some aspects, the communication devices 105 may perform one or more operations autonomously or in combination with an input by the user.

The Internet is an example of the communication network 120 that constitutes an Internet Protocol (IP) network consisting of multiple computers, computing networks, and other communication devices located in multiple locations, and components in the communication network 120 (e.g., computers, computing networks, communication devices) may be connected through one or more telephone systems and other means. Other examples of the communication network 120 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 120 may include of any combination of networks or network types. In some aspects, the communication network 120 may include any combination of communication mediums such as coaxial cable, copper cable/wire, fiber-optic cable, or antennas for communicating data (e.g., transmitting/receiving data).

A communication device 105 may support any number of applications (e.g., ranking application 106, scheduling application 107, enterprise management application 108). In some aspects, the applications may be stored on memory of the communication device 105 and executed by the communication device 105. In some cases, the applications may include cloud-based applications or server-based applications (e.g., supported and/or hosted by the server 110).

In an example, the ranking application 106 may support features associated with ranking of members (e.g., employees, contract workers) of one or more workforces. In some examples, the scheduling application 107 may support features associated with scheduling members for temporal periods (e.g., time-slots, shifts) and/or workstations associated with one or more enterprises (e.g., employers). In some aspects, the enterprise management application 108 may support features associated with labor sharing among different enterprises. These and other example aspects of the applications will be described in further detail herein.

A “member” of a workforce as referred to herein may include, for example, full-time employees, part-time employees, contract workers (e.g., independent contractors or non-employees such as “gig workers”), supervisees, supervisors, managers (e.g., lower-level managers, upper-level managers, etc.) and the like. Each “member” capable of performing a work task may also be referred to as a “service provider.” In some aspects, the members may be associated with the same workforce of an enterprise. In some aspects, the members may be associated with different workforces. In an example, each workforce may be associated with a different respective enterprise. In some other aspects, each workforces may be associated with different respective enterprise. The term “enterprise” may also be referred to herein as an “organization.”

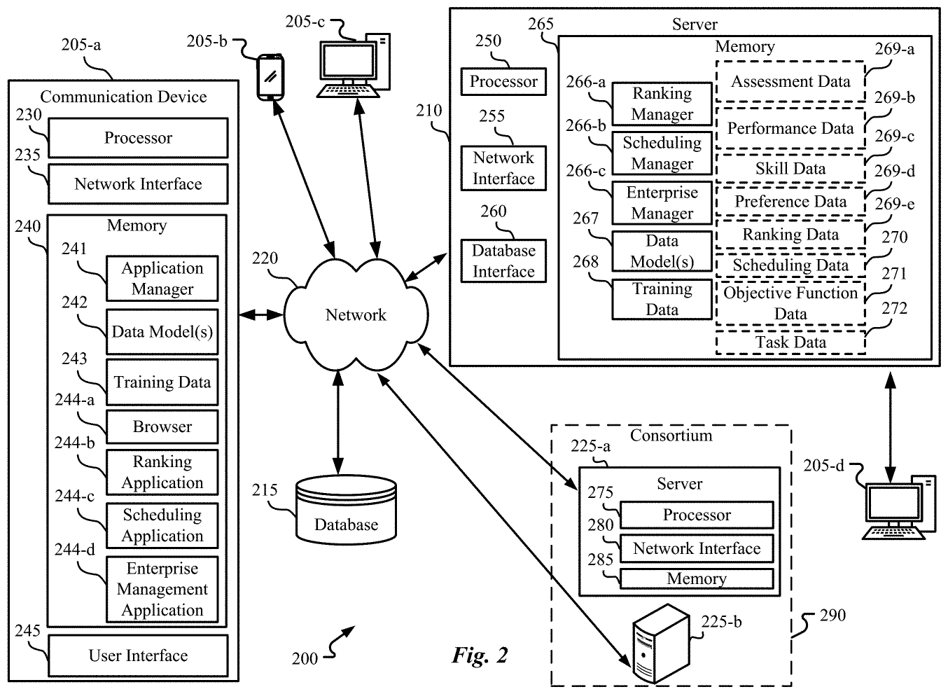

The server 110 may support various managers (e.g., ranking manager 111, scheduling manager 112, enterprise manager 113), also referred to herein as ‘engines.’ The ranking manager 111 may support features associated with ranking of members (e.g., employees, contract workers) of one or more workforces. In some examples, the scheduling manager 112 may support features associated with scheduling members for temporal periods (e.g., time-slots, shifts) and/or workstations associated with one or more enterprises (e.g., employers). In some aspects, the enterprise manager 113 may support features associated with labor sharing among different entities (e.g., labor sharing among different enterprises, among different businesses associated with the same enterprise, etc.). These and other example aspects of the various managers will be described in further detail herein with reference to FIG. 2.

The servers 125 (and corresponding databases 130) may be associated with information silos (e.g., insular management systems) of respective enterprises. The server 110 may support establishing an enterprise data exchange with the servers 125. In an example, the servers 125 may be included in a consortium 135 of enterprises, where the consortium 135 is managed by an enterprise associated with the server 110. The server 110 may receive information from the servers 125 via enterprise data exchange. The received information may include, for example, member data (e.g., worker attributes, worker scheduling information, etc.) and/or enterprise demand (e.g., demand for workers) corresponding to each respective enterprise.

The server 125-a may be electrically coupled to and/or in communication with the database 130-a (e.g., via a wired or wireless communications link associated with the server 125-a and the database 130-a). The server 125-b may be electrically coupled to and/or in communication with the database 130-b (e.g., via a wired or wireless communications link associated with the server 125-b and the database 130-b).

Example aspects of components and functionalities of the communication devices 105, the server 110, the database 115, the communication network 120, and the servers 125 are provided with reference to FIG. 2.

While the illustrative aspects, embodiments, and/or configurations illustrated herein show the various components of the system 100 collocated, certain components of the system 100 can be located remotely, at distant portions of a distributed network, such as a Local Area Network (LAN) and/or the Internet, or within a dedicated system. Thus, it should be appreciated, that the components of the system 100 can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

### AHP for Ranking/Scheduling of Workers

The scheduling of hourly workers in a business may present numerous challenges. For example, numerous constraints specific to an individual business must be adhered when creating a schedule that accommodates for worker availability, worker ability, and open time slots to be filled. For example, some workers may wish to maximize their respective hours, but the same workers may have availability preferences (e.g., desired working times, desired positions or tasks, etc.), task preferences, and or skillsets which may not align with time-slots to be filled.

Some businesses, in general, may wish to maximize profit while also abiding by the preferences and/or skillsets associated with the pool of workers included in an available workforce. In some cases, individual workers may vary based on skillset and/or productivity, which may impact the ability of an employer (e.g., a manager) to efficiently assign workers to available time-slots and/or available positions (e.g., workstations) associated with a work schedule. In some cases, the productivity of a worker may be based on a combination of subjective ratings (e.g., reliability, flexibility, skill level, etc.) and objective performance metrics (e.g., measurable metrics based on criteria such as punctuality, efficiency, etc.). Techniques supportive of selecting and assigning workers for a work schedule while optimizing for a variety of metrics (e.g., employer preferences, worker preferences, worker productivity, worker skillsets, etc.) are desired.

According to example aspects of the present disclosure, techniques are described for applying analytic hierarchy process (AHP) techniques for scheduling workers with respect to available work shifts or time-slots of a schedule. In an example, each worker may be provided with a communications device via which the worker may receive, view, accept, and/or reject a proposed schedule (e.g., one or more proposed work shifts or time-slots associated with a time period). A server (e.g., using a ranking manager and/or scheduling manager described herein) may prepare a schedule based on various metrics associated with each worker of the workforce.

For example, the server (e.g., a ranking manager implemented at the server) may gather a number of metrics for each worker, such as objective metrics (e.g., attendance, punctuality, efficiency) and subjective metrics. The subjective metrics may be, for example, subjective and sparser data provided by one or more judges (e.g., current managers, former managers) with respect to worker performance. In an example, the server may combine the objective metrics and subjective metrics using AHP, based on which the server may produce a composite ranking (e.g., a single overall metric, also referred to herein as composite worker ranking) for each worker.

The server (e.g., a scheduling manager implemented at the server) may apply the composite ranking as an input to an objective function when determining (e.g., establishing, setting) a proposed work schedule. In some aspects, the server may determine a proposed work schedule that minimizes the objective function subject to a set of parameters or constraints. In some examples, the objective function may be parameterized to provide varying weights to different criteria in the scheduling process.

Example aspects applying AHP techniques for producing composite worker rankings and scheduling workers based on the composite worker rankings are described herein with reference to FIGS. 2 through 5 and FIG. 8.

Aspects of the scheduling techniques described herein may be implemented to realize one or more advantages. For example, the described techniques may support improved scheduling efficiency compared to some systems. Some example advantages may include: an ability to combine objective and subjective performance metrics; an ability to parameterize different objectives in the objective function; an ability to use historical information (e.g., past schedules) to as a parameter for determining current schedules; and an ability to combine worker evaluations generated by multiple judges (e.g., managers).

### Dynamic and Iterative Scheduling of Workers

According to other example aspects of the present disclosure, techniques are described for iteratively scheduling workers based on composite worker rankings and feedback from workers. In an example, the techniques may include multiple scheduling passes or iterations for proposing work shifts (and/or time-slots) to a set of workers based on a priority order corresponding to composite worker rankings. In some aspects, the techniques may include a set of algorithms (e.g., scheduling algorithms, worker acceptance algorithm, worker rejection algorithm) for processing acceptance and rejection decisions by workers.

For example, a server (e.g., scheduling manager) may offer a shift to a first worker having the highest composite worker ranking (e.g., most productive workers). If the first worker rejects the shift (or the first worker does not accept the shift within a minimum decision time), the server may offer the same shift to a second worker having the second highest composite worker ranking. Alternatively, or additionally, if the first worker accepts the shift, the server (e.g., in another scheduling pass) may offer a next available shift to the second worker. The server may continue offering and assigning shifts to workers until a final schedule is complete (e.g., all shifts have been accepted by and assigned to a worker).

In some examples, once the final schedule is complete, the server may assign the workers to workstations (e.g., work tasks) associated with the assigned shifts. In an example, the server may offer the workstations to the workers over multiple scheduling passes or iterations based on the priority order corresponding to the composite worker rankings. In some aspects, when assigning the workers to the workstations, the server may apply the set of algorithms (e.g., worker acceptance algorithm, worker rejection algorithm) described herein for processing acceptance and rejection decisions by the workers.

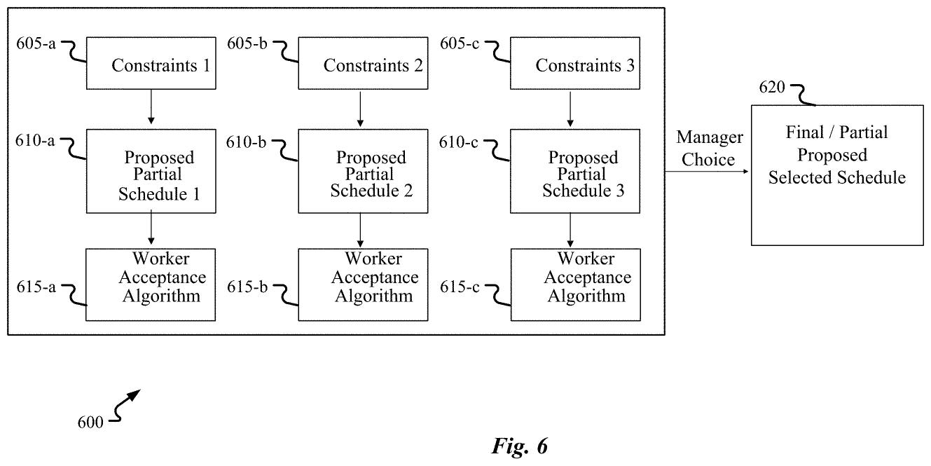

Example aspects of iteratively scheduling workers to work shifts and workstations based on the composite worker rankings are described herein with reference to FIGS. 6, 7, and 9.

Aspects of the scheduling techniques described herein may be implemented to realize one or more advantages. For example, the described techniques may support improved scheduling efficiency compared to some systems. Some other example advantages may include improved scheduling transparency and scheduling control compared to some systems.

### Labor Sharing Platform

According to some example aspects of the present disclosure, techniques are described for labor sharing among members (e.g., enterprises, organizations) of a consortium. A ‘consortium’ may also be referred to herein as a network of members. For example, aspects of the present disclosure include an HCM platform that supports the sharing of worker data (e.g., skill sets, scheduling information, preference information, etc.) and/or worker demand between members of the consortium, for example, through enterprise data exchange. The platform may support matching available workers within the consortium to worker demand (e.g., work tasks).

For example, a server (e.g., an enterprise manager implemented at the server) may identify a work task associated with a first member of the consortium. The server may select, from among a set of workers associated with a second member of the consortium, one or more workers that may be compatible with the work task. For example, the server may identify and select a worker that is compatible with the work task based on parameters associated with the work task (e.g., task type, scheduling information associated with the work task, compensation, location) and/or worker data associated with the worker (e.g., skill set information, scheduling information, preference information associated with work tasks). In an example, the server may output a notification associated with the work task to a device of the selected worker. In some aspects, the notification may include an indication of the work task, the parameters associated with the work task, and/or identification information (e.g., name, location) of the first member associated with the work task.

In some aspects, the platform may support worker matching in response to referral requests (e.g., an indication of a work task, a request for a worker capable of performing the work task) indicated by members of the consortium. For example, the identified work task may be associated with a referral request by the first member. In some other aspects, the platform may support worker matching in response to referral recommendations indicated by members. The referral recommendations may include, for example, an indication of an available workers, skill set information associated with the available workers, scheduling information (e.g., scheduling availability) associated with the available workers.

Aspects of the scheduling techniques described herein may be implemented to realize one or more advantages. For example, the described techniques may support increased worker retention and higher worker satisfaction by offering workers increased work opportunities (e.g., work hours) and increased work flexibility. In some aspects, the described techniques for labor sharing may support reduced overhead associated with HCM (e.g., reducing overhead associated with interviewing, onboarding, and hiring workers).

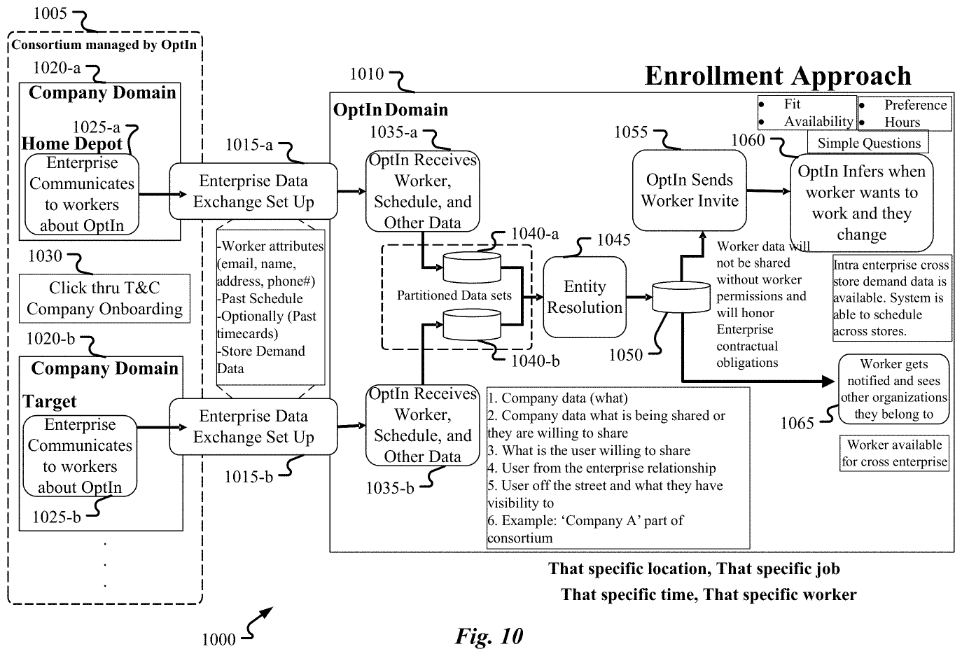

Example aspects of labor sharing among members of a consortium are described herein with reference to FIGS. 10 through 17.

FIG. 2 illustrates an example of a system 200 that supports an enterprise platform for worker ranking, worker scheduling, and labor sharing in accordance with aspects of the present disclosure.

In some examples, the system 200 may be implemented by aspects of the system 100 described with reference to FIG. 1. The system 200 may include communication devices 205 (e.g., communication device 205-a through communication device 205-d), a server 210, a database 215, a communication network 220, and servers 225. The communication devices 205, the server 210, the database 215, the communications network 220, and the servers 225 may be implemented by like elements described herein with reference to FIG. 1.

In various aspects, settings of the any of the communication devices 205, the server 210, or the servers 225 may be configured and modified by any user and/or administrator of the system 200. Settings may include settings related to how content is managed. Settings may be configured to be personalized for one or more communication devices 205, users of the communication devices 205, and/or other groups of entities (e.g., workers, groups of workers, enterprises, a consortium of enterprises, etc.), and may be referred to herein as profile settings, user settings, enterprise settings, or organization settings. In some examples, the rules and/or settings may be personalized by a user and/or administrator for any variable, parameter, user (user profile, member profile), entity (e.g., enterprise), communication device 205, server 210, or server 225.

A communication device 205 (e.g., communication device 205-a) may include a processor 230, a network interface 235, a memory 240, and a user interface 245. In some examples, components of the communication device 205 (e.g., processor 230, network interface 235, memory 240, user interface 245) may communicate over a system bus (e.g., control busses, address busses, data busses) included in the communication device 205. In some cases, the communication device 205 may be referred to as a computing resource.

In some cases, the communication device 205 (e.g., communication device 205-a) may transmit or receive packets to one or more other devices (e.g., another communication device 205, the server 210, the database 215, a server 225) via the communication network 220, using the network interface 235. The network interface 235 may include, for example, any combination of network interface cards (NICs), network ports, associated drivers, or the like. Communications between components (e.g., processor 230, memory 240) of the communication device 205 and one or more other devices (e.g., another communication device 205, the database 215, the server 210) connected to the communication network 220 may, for example, flow through the network interface 235.

The processor 230 may correspond to one or many computer processing devices. For example, the processor 230 may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 240 of the communication device 205). For example, upon executing the instruction sets stored in memory 240, the processor 230 may enable or perform one or more functions of the communication device 205.

The processor 230 may utilize data stored in the memory 240 as a neural network. The neural network may include a machine learning architecture. In some aspects, the neural network may be configured for decision making processes based on Analytic Hierarchy Processing (AHP), example aspects of which are described herein. In some cases, the neural network may be or include an artificial neural network (ANN). In some other aspects, the neural network may be or include any machine learning network such as, for example, a deep learning network, a convolutional neural network, or the like. Some elements stored in memory 240 may be described as or referred to as instructions or instruction sets, and some functions of the communication device 205 may be implemented using machine learning techniques.

The memory 240 may include one or multiple computer memory devices. The memory 240 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 240, in some examples, may correspond to a computer-readable storage media. In some aspects, the memory 240 may be internal or external to the communication device 205.

The memory 240 may be configured to store instruction sets, neural networks, and other data structures (e.g., depicted herein) in addition to temporarily storing data for the processor 230 to execute various types of routines or functions. For example, the memory 240 may be configured to store program instructions (instruction sets) that are executable by the processor 230 and provide functionality of an application manager 241 described herein. The memory 240 may also be configured to store data or information that is useable or capable of being called by the instructions stored in memory 240. One example of data that may be stored in memory 240 for use by components thereof is a data model(s) 242 (inclusive of a neural network model(s) and/or AHD model(s)) and/or training data 243 (also referred to herein as a training data and feedback).

The application manager 241 may include a single or multiple engines. The communication device 205 (e.g., the application manager 241) may utilize one or more data models 242 for recognizing and processing information obtained from other communication devices 205, the server 210, the database 215, and the servers 225. In some aspects, the communication device 205 (e.g., the application manager 241) may update one or more data models 242 based on learned information included in the training data 243. In some aspects, the application manager 241 and the data models 242 may support forward learning based on the training data 243.

The application manager 241 may include any number of managers (e.g., processing engines, decision engines, learning engines) applicable to processing operations and/or decision operations described herein (e.g., worker ranking, worker scheduling, and enterprise labor sharing techniques). In some examples, the application manager 241 may include any number of managers applicable to processing operations and/or decision operations associated with the ranking application 244-b, the scheduling application 244-c, and/or the enterprise management application 244-d. The application manager 241 may include examples of aspects of any of the ranking manager 266-a, the scheduling manager 266-b, the enterprise manager 266-c described herein with reference to the server 210. For example, any of the application manager 241, the ranking manager 266-a, the scheduling manager 266-b, and the enterprise manager 266-c may be implemented at a communication device 205 and/or the server 210.

The application manager 241 may have access to and use one or more data models 242. For example, the data model(s) 242 may be built and updated by the application manager 241 based on the training data 243. The data model(s) 242 may be provided in any number of formats or forms. Non-limiting examples of the data model(s) 242 include Decision Trees, Support Vector Machines (SVMs), Nearest Neighbor, and/or Bayesian classifiers.

The data model(s) 242 may include an AHP decision-making model. AHP is a method of converting multiple relative value judgments of criteria into a linear list of absolute value judgments. AHP is a technique based on entering the relative judgments into a square positive reciprocal matrix whose rows and columns contain the relative judgment ratios for pair-wise comparisons of indicator values. AHP provides advantages in that the relative judgments do not have to be totally consistent with each other (e.g., some pairwise-comparison matrix (PCM) entries may remain unfilled, aspects of which are described herein). In some aspects, pair-wise ratio judgments included in a positive reciprocal matrix may be expressed as integer values and corresponding reciprocal values.

In some aspects, AHP may support multiple levels of prioritization. For example, AHP techniques applied to aspects of the present disclosure may include the following:

Let c₁, . . . c_{N} be a set of indicators for a given merchant-based category.

Let the subjective judgment for the relative importance of indicator cᵢ to that of cⱼ be represented by (n×n) matrix A=(aᵢⱼ)_{i,j=1, . . . , N}, where N=number of indicators.

The matrix A maintains reciprocity, i.e. If aᵢⱼ=ν, then

$${a}_{ji} = \frac{1}{v} .$$

Compute the maximum (Perron) eigenvalue λₘₐₓ of A.

Compute the (Perron) eigenvector w̅, such that the vector w̅ is the vector of absolute priorities.

The eigenvalue λₘₐₓ provides a rough consistency index

$$( CI ) = \frac{( {λ}_{max} ( ) )}{( N - 1 )} .$$

AHP techniques supported by the system 200 (e.g., server 210) may include normalizing the CI by an expected random index (RI) value for the same order matrix to obtain the consistency ratio (CR)

$$( i . e . , CR = \frac{CI}{RI} ) .$$

Examples of the AHP techniques and AHP hierarchies described herein may be applied to a retail delivery use case. In an example case of AHP hierarchies applied to a retail delivery business, an ‘indoor employee ranking’ may include categories such as ‘relevant skills’ (e.g., opener/closer, efficiency, pizza-making skills, etc.) and ‘relevant personality traits’ (e.g., reliability, flexibility, compatibility). In another example applied to a retail delivery business, ‘driver rankings’ may include parameters such as reliability, flexibility, driver safety, and driver efficiency.

The AHP rankings described herein may be based on a scale. That is, for example, the AHP scale for pairwise ratio comparisons may include a numerical range of 1 to 9. The dynamic range of the ratios of various metrics described herein (e.g., objective metrics, subjective evaluations, scores) may include values in the range of 1 to 9. A ratio of 9 to 1, for example, of a ‘worker A’ to a ‘worker B’ may represent the highest level of preference of ‘worker A’ compared to ‘worker B’ with respect to a criterion (e.g., efficiency, reliability, driver safety, tardiness, etc.). A ratio of 1 for this comparison would represent equal preference.

In some aspects of the present disclosure, the system 200 (e.g., via AHP) may support using numerical data for comparative ranking among workers with respect to any criteria. In some aspects, the system 200 may support merging comparative rankings (e.g., based on employee tardiness and other criteria) with other AHP qualitative evaluations described herein.

An example of comparative ranking and pair-wise ratio judgements is described herein with respect to an example objective metric (e.g., worker tardiness). In an example, the system 200 may support using numerical data for employee tardiness for comparative ranking among workers. In an example, measures of tardiness may be based on a tardiness threshold T, beyond which (e.g., less than, greater than) such tardiness may be configured as being unacceptable. In some examples, for incidents of tardiness below the threshold T (e.g., excluding any tardiness above the threshold T), the server 210 (e.g., ranking manager 266-a) may compute an aggregate measure over a time period for each worker. The aggregate measure may be, for example, an average tardiness or a median tardiness.

In an example, incidents of on-time arrivals may be included in the aggregate computation (e.g., where on-time arrivals correspond to an entry value of ‘0’). In some aspects, units of measure associated with tardiness may be expressed in any temporal units (e.g., minutes, seconds, etc.). In some cases, the system 200 may support penalizing workers for arriving early (e.g., with respect to a temporal threshold) for a time-slot or shift.

In an example, a tardiness average a equal to 0 may be mapped to a tardiness score equal to 9. The threshold T for tardiness averages α may be mapped to a tardiness score equal to 1. Other tardiness averages α, 0≤α≤T, may be mapped as:

$$s = 9 - ( \frac{8}{T} ) α .$$

For example, for a worker who is always on time (e.g., α=0), the server 210 (e.g., ranking manager 266-a) may determine a tardiness score equal to 9 for the worker. In another example, for an employee at the maximum amount of acceptable tardiness (e.g., α=T), the server 210 (e.g., ranking manager 266-a) may determine a tardiness score equal to 1 for the worker.

The dynamic range of the ratios of the tardiness aggregate scores for pairs of employees may include values in the range of 1 to 9. With respect to the criterion of tardiness, for example, a ratio of 9 to 1 of ‘worker A’ to ‘worker B’ may represent the highest level of preference of ‘worker A’ compared to ‘worker B’ under the criterion of tardiness. A ratio of 1 for this comparison may represent an equal preference.

Based on the aggregate measures described herein, the server 210 (e.g., ranking manager 266-a) may compare any pair of employees with respect to one or more categories (e.g., efficiency, reliability, driver safety, tardiness, etc.) by forming pair-wise numerical ratios based on the one or more categories. The ratios may be expressed as values included in the AHP range of 1 to 9.

For example, with respect to an example category of tardiness, the ratio of an on-time employee (e.g., tardiness score equal to 9) compared to a maximum acceptable tardiness employee (e.g., tardiness score equal to 1) is equal to 9. In another example, the ratio of an on-time employee to another on-time employee is equal to 1. In another example, the ratio of a maximum acceptable tardiness employee to another maximum acceptable tardiness employee is equal to 1.

In some examples, the training data 243 may include data communicated between the communication device 205 and other communication devices 205, the server 210, a server 225, etc. In some aspects, the training data 243 may include decisions, outputs, or predictions generated by the data model(s) 242 described herein.

The application manager 241 may be configured to analyze content, which may be any type of information, including information that is historical or in real-time. The application manager 241 may be configured to receive information from other communication devices 205, the server 210, and/or the server 225. The application manager 241 may be configured to analyze profile information associated with one or more users, groups, etc. The profile information can include any type of information, including audio and visual information. The application manager 241 may build any number of user profiles using automatic processing, using artificial intelligence and/or using input from one or more users associated with the communication devices 205. The application manager 241 may use automatic processing, artificial intelligence, and/or inputs from one or more users of the communication devices 205 to determine, manage, and/or combine information relevant to a user profile.

The application manager 241 may determine user profile information based on a user's interactions with information. The application manager 241 may update (e.g., continuously, periodically) user profiles based on new information that is relevant to the user profiles. The application manager 241 may receive new information from any communication device 205, the server 210, the database 215, etc. Profile information may be organized and classified in various manners. In some aspects, the organization and classification of profile information may be determined by automatic processing, by artificial intelligence and/or by one or more users of the communication devices 205.

The application manager 241 may create, select, and execute appropriate processing decisions. Processing decisions may include content management, content extraction, and content analysis. In some aspects, processing decisions may include decisions associated with worker rankings, worker scheduling, and/or labor sharing implemented by a communication device 205 and/or the server 210. Content, for example, may include any data stored in the memory 240 and/or accessed by the communication device 205 (e.g., data accessed from the database 215, the memory 265, the memory 285, etc.). Illustrative examples of content management include rearranging content, modifying content, inputting content, showing and/or hiding content. Processing decisions may be handled automatically or semi-autonomously by the application manager 241, with or without human input.

The application manager 241 may store, in the memory 240 (e.g., in a database included in the memory 240), data such as worker assessment data, worker performance data, worker skillset data, worker preference data, worker ranking data, worker scheduling data, objective function data, enterprise task data, and/or worker information (e.g., identification information). Example aspects of such data are described herein with reference to assessment data 269-a, performance data 269-b, skillset data 269-c, preference data 269-a, ranking data 269-e, scheduling data 270, objective function data 271, and enterprise task data 272. In some aspects, the assessment data 269-a, performance data 269-b, skillset data 269-c, preference data 269-a, ranking data 269-e, scheduling data 270, objective function data 271, and enterprise task data 272 described herein may be stored on any combination of the memory 240, the memory 265, a database 215, or the like.

In some cases, the application manager 241 may store data communicated between the communication device 205 and other devices (e.g., other communication devices 205, the server 210, a server 225, etc.). Data within the database of the memory 240 may be updated, revised, edited, or deleted by the application manager 241. In some aspects, the application manager 241 may support continuous, periodic, and/or batch fetching of content (e.g., content referenced within member evaluations or rankings, member schedules, member information, preferences or parameters related to a user, etc.) and content aggregation.

The communication device 205 may render a presentation (e.g., visually, audibly, using haptic feedback, etc.) of an application 244 (e.g., a browser application 244-a, a ranking application 244-b, a scheduling application 244-c, an enterprise management application 244-d). In an example, the communication device 205 may render the presentation via the user interface 245. The user interface 245 may include, for example, a display (e.g., a touchscreen display), an audio output device (e.g., a speaker, a headphone connector), or any combination thereof. In some aspects, the applications 244 may be stored on the memory 240. In some cases, the applications 244 may include cloud-based applications or server-based applications (e.g., supported and/or hosted by the server 210). Settings of the user interface 245 may be partially or entirely customizable and may be managed by one or more users, by automatic processing, and/or by artificial intelligence.

In an example, any of the applications 244 (e.g., browser application 244-a, ranking application 244-b, scheduling application 244-c, enterprise management application 244-d) may be configured to receive data in an electronic format and present content of data via the user interface 245. For example, the applications 244 may receive data from another communication device 205, the server 210, or a server 225 via the communications network 220, and the communication device 205 may display the content via the user interface 245.

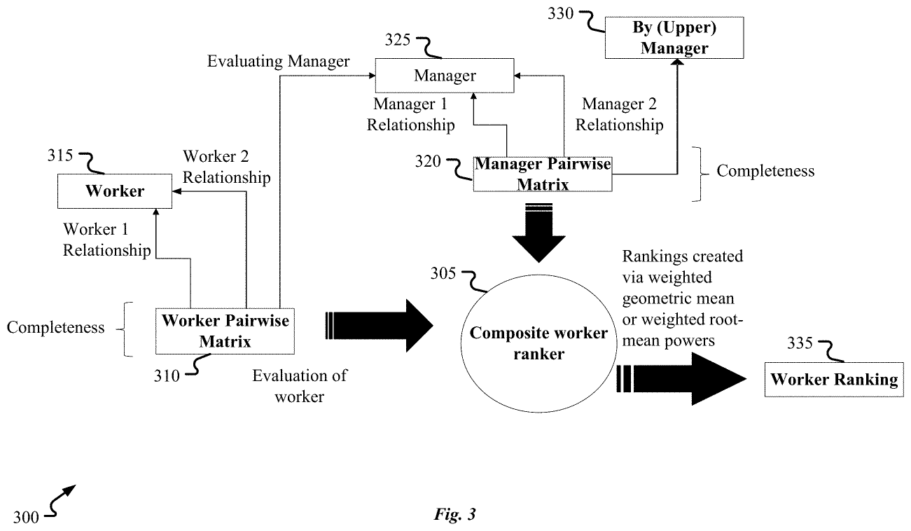

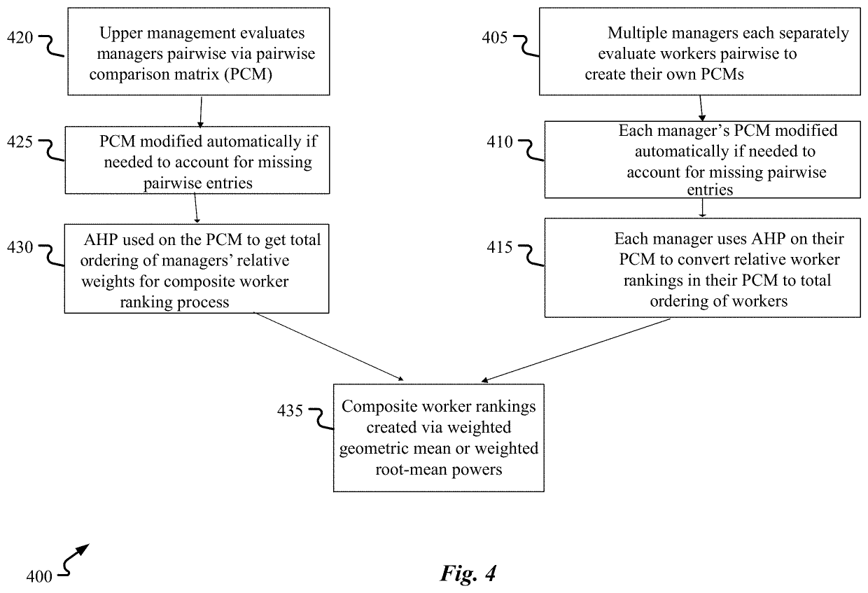

The ranking application 241-b may support features associated with ranking of members (e.g., employees, contract workers) of one or more workforces. Example aspects of the ranking application 241-b are described with reference to FIGS. 3 and 4.

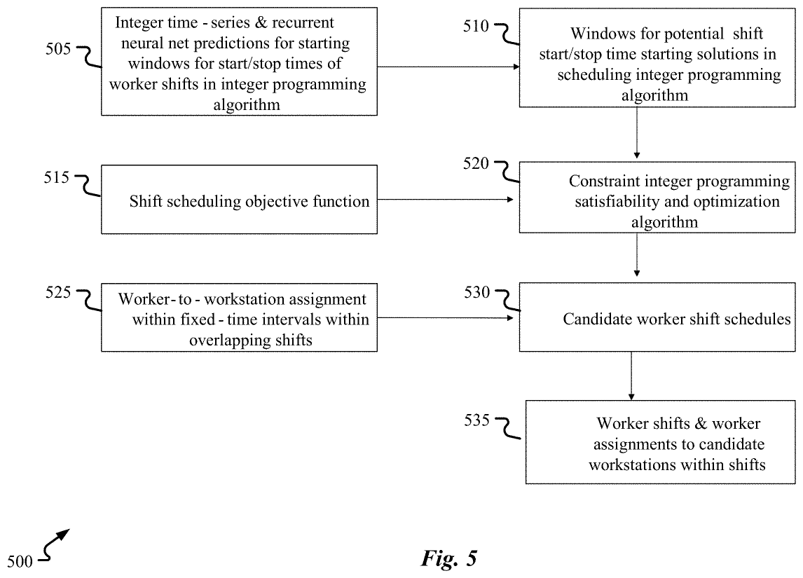

The scheduling application 244-c may support features associated with scheduling members for temporal periods (e.g., time-slots, shifts) and/or workstations associated with one or more enterprises (e.g., employers). Example aspects of the scheduling application 244-c are described with reference to FIGS. 5 through 7.

The enterprise management application 244-d may support features associated with labor sharing among different enterprises. Example aspects of the enterprise management application 244-d are described with reference to FIGS. 10 through 16.

In some cases, any of the ranking application 241-b, the scheduling application 244-c, and the enterprise manager 266-c applications may include cloud-based applications or server-based applications (e.g., supported and/or hosted by the server 210).

The database 215 may include a relational database, a centralized database, a distributed database, an operational database, a hierarchical database, a network database, an object-oriented database, a graph database, a NoSQL (non-relational) database, etc. In some aspects, the database 215 may store and provide access to, for example, any of the stored data described herein.

The server 210 may include a processor 250, a network interface 255, a database interface 260, and a memory 265. In some examples, components of the server 210 (e.g., processor 250, network interface 255, database interface 260, memory 265) may communicate over a system bus (e.g., control busses, address busses, data busses) included in the server 210. The processor 250, network interface 255, and memory 265 of the server 210 may include examples of aspects of the processor 230, network interface 235, and memory 240 of the communication device 205 described herein.

For example, the processor 250 may be configured to execute instruction sets stored in memory 265, upon which the processor 250 may enable or perform one or more functions of the server 210. In some aspects, the processor 250 may utilize data stored in the memory 265 as a neural network (e.g., configured for decision-making processes based on AHP). In some examples, the server 210 may transmit or receive packets to one or more other devices (e.g., a communication device 205, the database 215, another server 210, a server 225) via the communication network 220, using the network interface 255. Communications between components (e.g., processor 250, memory 265) of the server 210 and one or more other devices (e.g., a communication device 205, the database 215, a server 225) connected to the communication network 220 may, for example, flow through the network interface 255. The network interface 255 may support, for example, enterprise data exchange between the server 210 and the servers 225.

In some examples, the database interface instructions 260 (also referred to herein as database interface 260), when executed by the processor 250, may enable the server 210 to send data to and receive data from the database 215 (or a database associated with a server 225). For example, the database interface instructions 260, when executed by the processor 250, may enable the server 210 to generate database queries, provide one or more interfaces for system administrators to define database queries, transmit database queries to one or more databases (e.g., database 215, a database associated with a server 225), receive responses to database queries, access data associated with the database queries, and format responses received from the databases for processing by other components of the server 210.

The memory 265 may be configured to store instruction sets, neural networks, and other data structures (e.g., depicted herein) in addition to temporarily storing data for the processor 250 to execute various types of routines or functions. For example, the memory 265 may be configured to store program instructions (instruction sets) that are executable by the processor 250 and provide functionality of various managers 266 described herein. One example of data that may be stored in memory 265 for use by components thereof is a data model(s) 267 (e.g., AHP model, a neural network model) and/or training data 268. Other examples of data that may be stored in the memory 265 for use by components thereof include assessment data 269-a, performance data 269-b, skillset data 269-c, preference data 269-a, ranking data 269-e, scheduling data 270, objective function data 271, enterprise task data 272, and/or member information (e.g., identification information, user credentials, etc.).

The data model(s) 267 and the training data 268 may include examples of aspects of the data model(s) 242 and the training data 243 described with reference to the communication device 205. For example, the server 210 (e.g., ranking manager 266-a, scheduling manager 266-b, enterprise manager 266-c) may utilize one or more data models 267 for recognizing and processing information obtained from communication devices 205, another server 210, the database 215, and/or a server 225. In some aspects, the server 210 (e.g., ranking manager 266-a, scheduling manager 266-b, enterprise manager 266-c) may update one or more data models 267 based on learned information included in the training data 268.

In an example, the training data 268 may include data on worker behavior in relation to work shifts for which the workers are scheduled to work. In an example, the training data 268 may include temporal information (e.g., punctuality, tardiness) associated with workers and previously scheduled work shifts. In another example, the training data 268 may include attendance information associated with previously scheduled work shifts. In some other examples, the training data 268 may include worker responses (e.g., shift acceptance, shift refusal) and other behavior (e.g., shift changing) with respect to previously proposed work shifts and/or previously confirmed work shifts.

In some aspects, the training data 268 associated with a worker may be provided by the worker, by their co-workers, and/or by their managers (e.g., via a ranking application 241-b and/or a scheduling application 244-c at a communication device 205). In some other aspects, the training data 268 may be provided by automated scheduling tools (e.g., scheduling application 244-c, scheduling manager 266-b).

Aspects of the present disclosure may support using the training data 268 to evaluate the quality of workers (e.g., objective metrics, subjective metrics, and/or worker rankings described herein). In an example, the server 210 (e.g., scheduling manager 266-b) may apply the training data 268 to improve processing decisions associated with worker rankings and/or worker scheduling (e.g., assigning workers to future shifts), thereby supporting improved scheduling outcomes both for workers and their employers.

For example, the server 210 may apply the training data 268 (e.g., past worker behavior with respect to previously proposed work shifts and/or previously confirmed work shifts) to predict future worker behavior. In an example, when generating a work schedule, the server 210 (e.g., scheduling manager 266-b) may utilize the data models 267 and training data 268 to generate probability information and confidence information corresponding to predicted worker behavior with respect to a proposed work shift.

In an example, the probability information may include a probability score (e.g., from 0.00 to 1.00) of whether a worker will accept a proposed work shift, reject the proposed work shift, and/or propose an alternative work shift. In another example, the probability information may include a probability score associated with a predicted timeliness (e.g., punctuality, tardiness) of a worker with respect to a scheduled work shift. In another example, the probability information may include a probability score associated with a predicted attendance of the worker with respect to a scheduled work shift. The confidence information, for example, may include a confidence score (e.g., from 0.00 to 1.00) corresponding to a respective probability score. In some cases, based on the probability information and/or the confidence information, the server 210 (e.g., scheduling manager 266-b) may determine whether to offer a worker a proposed work shift.

The training data 268 may serve as an input into the AHP algorithm (AHP techniques described herein). For example, the training data 268 may be input into the data models 267 (AHP decision-making models) described herein. For example, based on the training data 268, the server 210 (e.g., ranking manager 266-a) may generate composite evaluation data associated with each worker.

The ranking manager 266-a, the scheduling manager 266-b, and the enterprise manager 266-c may implement example aspects of ranking, scheduling, and enterprise labor sharing associated with members of a workforce(s) as described herein.

For example, the ranking manager 266-a may support techniques described herein associated with generating ranking information (e.g., composite worker rankings) of members (e.g., employees, contract workers) of one or more workforces. Example aspects of the ranking manager 266-a are described with reference to FIGS. 3 and 4.

The scheduling manager 266-b may support techniques described herein associated with scheduling members for temporal periods (e.g., time-slots, work shifts) and/or workstations associated with one or more enterprises (e.g., employers). Example aspects of the scheduling manager 266-b are described herein with reference to FIGS. 5 through 7.

The enterprise manager 266-c may support techniques described herein associated with labor sharing among different entities (e.g., labor sharing among different enterprises, among different businesses associated with the same enterprise, etc.). Example aspects of the enterprise manager 266-c are described herein with reference to FIGS. 10 through 16.

The assessment data 269-a may include subjective evaluations (also referred to herein as subjective data, subjective metrics, or subjective ratings information) of worker attributes related to, for example, job roles, skill sets, etc. The subjective evaluations may be input, for example, via a ranking application 241-b described herein. For example, one or more workers (e.g., supervisors, managers) may provide subjective evaluations associated with another worker (e.g., employee, independent contractor) via a communication device 205 using the ranking application 241-b. In some aspects, the subjective assessments of a worker may include assessments input by the same worker (e.g., self-assessments) using the ranking application 241-b.

The subjective evaluations may be based on a scale. For example, the scale may be from 1 to 10, where 10 is the highest score (e.g., associated with an “excellent” rating) and 1 is the lowest score (e.g., associated with a “poor” rating). In some other examples, the subjective evaluations may be classifications such as, for example, “poor,” “satisfactory,” or “exceptional.” The subjective evaluations may include any combination of ranking and/or classification methods.

The worker attributes indicated in the subjective evaluations may be, for example, related to attributes or characteristics of an employee or job role. For example, worker attributes may include customer service skills, job completion timeliness, ability to prioritize and manage tasks, work product quality, etc. In an example, for an enterprise associated with a retail business (e.g., home improvement, retail consumer products, food service) the attributes may include qualifications associated with a task type (e.g., a worker is an opener/closer qualified for opening/closing a store). In some other examples, the attributes may include qualifications (also referred to herein as qualification data) associated with a skill set (e.g., pizza-making). In some aspects, the attributes may include personality traits (e.g., reliability, flexibility, compatibility with other members, driver safety), or the like.

The ranking manager 266-a may evaluate or rank a member based on the subjective evaluations included in the assessment data 269-a. Based on the assessment data 269-a, for example, the ranking manager 266-a may determine or calculate a subjective assessment of a worker (e.g., a relative level such as “average,” “above average,” “below average,” etc.) with respect to any combination of qualifications and personality traits.

In some aspects, the server 210 may support aggregation of subjective assessments provided by multiple workers (e.g., supervisors, managers) with respect to assessing another worker (e.g., employee, supervisee). For example, for a subjective assessment (e.g., reliability) associated with a worker, the ranking manager 266-a may generate combined or extrapolated data based on multiple subjective assessments provided by multiple workers (e.g., reliability assessments provided by multiple supervisors).

The performance data 269-b may include objective metrics (also referred to herein as performance metrics or objective assessments of performance). The objective metrics may include, for example, assessments identified or derived from any measured or other unbiased classification of the performance of a work task. The objective assessments may be measurable based on a scale such that the objective assessments are independent of a manager (e.g., supervisor, worker) reporting the data. For example, the objective assessments may be based on numerical data associated with a predicted execution time (e.g., predicted run-time) vs. an actual execution time for type of work task (e.g., actual run-time or total time associated with a driver delivery). In another example, the objective metrics may include efficiency associated with a type of work task (e.g., number of pizzas made, number of transactions completed, or the like with respect to a temporal period). In some other examples, the objective metrics may include numerical data for employee tardiness (e.g., tardiness with respect to a threshold, an average tardiness, a median tardiness, etc.) or non-tardiness (e.g., on-time arrivals, early arrivals, etc.).

The objective metrics may be input, for example, via the ranking application 241-b described herein. In some aspects, the objective metrics may be input by a manager (e.g., manually) via the ranking application 241-b and/or autonomously recorded by the ranking application 241-b. In an example, the communication device 205 may be a point-of-sale (POS) terminal capable of recording (e.g., at a POS application on the communication device 205) transactional information associated with the communication device 205 and a worker profile. The ranking application 241-b may extract (e.g., fetch), record, or calculate objective metrics (e.g., number of completed sales at the communication device 205 within a temporal period, efficiency associated with transactions, etc.) associated with the transactional information. In another example, the communication device 205 may be capable of recording timekeeping information such as arrival times (e.g., clocking-in, tardiness, etc.)

In some aspects, the ranking application 241-b and/or the ranking manager 266-a may extract, record, aggregate, or calculate the objective metrics autonomously (e.g., periodically, based on a schedule) or based on a trigger condition (e.g., a user input via the communication device 205, end of a work shift, end of day, task completion indicated by the communication device 205, etc.). In some aspects, the ranking manager 266-a may evaluate or rank a member based on the objective metrics included in the performance data 269-b.

The assessment data 269-a and the performance data 269-b may be employer driver and/or employee driven. For example, the server 210 may support objective and subjective rankings provided by any worker (e.g., supervisor, manager, supervisee, worker, independent contractor, etc.) with respect to another worker. For example, a supervisor may provide subjective evaluations and/or objective metrics associated with a worker (e.g., supervisee), and a worker (e.g., supervisee) may provide subjective evaluations and/or objective metrics associated with a supervisor. In another example, a higher-level manager may provide subjective evaluations and/or objective metrics associated with a lower-level manager.

The skill data 269-c may be generated and/or managed by the ranking manager 266-a. For example, the ranking manager 266-a generate a skills data set for each worker (e.g., supervisee, manager, etc.) based on the assessment data 269-a and the performance data 269-b. In an example, the ranking manager 266-a may generate skills data sets for each member based on the subjective evaluations and objective metrics described herein. In some aspects, a skills data set may define a set of skills or abilities of a worker (e.g., supervisee, manager) associated with performing one or more work tasks. In some aspects, a skills data set may include skills (e.g., abilities, aptitudes, competencies, deficiencies, and the like) of a worker and/or proficiencies (e.g., subjective metrics and/or objective metrics) of the worker with respect to the skills.

The preference data 269-a may include worker preferences. In some aspects, the worker preferences may include time-slot preferences associated with each worker. In some other aspects, the worker preferences may include work task preferences (e.g., preferences for a work task type) associated with each member.

The ranking data 269-e may be generated by the server 210 (e.g., the ranking manager 266-a). The ranking data 269-e may include, for example, a composite ranking associated with each member. In an example, the ranking manager 266-a may generate the composite rankings based on the subjective evaluations included in the assessment data 269-a and the objective metrics included in the performance data 269-b. For example, the ranking manager 266-a may combine the subjective evaluations and the objective metrics using AHP techniques described herein. In some aspects, when applying AHP techniques, the server 210 may ensure or monitor that the dynamic ranges of the subjective evaluations and the objective metrics (objective numerical data) are the same.

Example aspects of generating the ranking data 269-e (e.g., composite rankings) are described with reference to FIGS. 3 and 4.

The scheduling data 270 may include scheduling information associated with generated schedules. For example, the scheduling data 270 may include work shifts, worker assignments to each work shift, time-slots (e.g., time intervals), worker assignments to each time-slot, worker assignments to available workstations or work tasks, etc. In some aspects, the scheduling data 270 may include any combination of confirmed schedules, scheduling choices by members (e.g., real-time or historical), proposed schedules (e.g., proposed work shifts pending a response from a worker), proposed scheduling modifications, or the like.

The objective function data 271 may include a set of parameters or variables based on which the scheduling manager 266-b may generate a work schedule as described herein. The parameters may include, for example, time-slot preferences for workers, maximum hours assignable to a worker for a temporal period (e.g., 12 hours per day, 37.5 hours per week). In some aspects, the parameters may include minimum hours assignable to a worker for a temporal period (e.g., minimum of 3 hours per shift) or between temporal periods (e.g., minimum of 2 hours between shifts).

In some aspects, the scheduling manager 266-b may incorporate the objective function data 271 when generating a work schedule as described herein.

The task data 272 (also referred to herein as enterprise task data or customer task data) may include work tasks requested by customers (e.g., enterprises associated with a consortium 290 of enterprises). In some aspects, work tasks included in the task data 272 may include requirements or requests associated with different customers (e.g., enterprises such as Home Depot, Target, etc.). For example, customer A may be a retailer (e.g., Home Depot) requesting a set of work tasks (e.g., managers, cashiers, gardening) corresponding to customer A, and customer B may be a retailer (e.g., Target) requesting a set of work tasks (e.g., managers, cashiers, gardening), and customer C may be a food service (e.g., a pizza restaurant) requesting a set of work tasks (e.g., managers) associated with customer C. Customers A through C may each be associated with a server 225 of a member included in the consortium 290 (e.g., Customer A may be associated with server 225-a, Customer B may be associated with server 225-b).

In some aspects, the task data 272 may include customer preferences corresponding to attributes or performance levels associated with the requested work tasks. For example, the customer preferences may be associated with parameters such as experience level, abilities or skill sets, proficiency (e.g., objective metrics) associated with the skill sets, subjective metrics preferences (e.g., reliability, flexibility), etc.

The server 210 may support enterprise data exchange with the servers 225. For example, the servers 225 may be associated with information silos (e.g., insular management systems) of respective enterprises. The server 210 may support establishing an enterprise data exchange with the servers 225. In an example, the servers 225 may be included in the consortium 290, where the consortium 290 is managed by an enterprise associated with the server 210. In some aspects, server 210 may support management of customers (e.g., Customer A, Customer B) of the consortium 290.

The server 210 and the servers 225 may support a data exchange platform (e.g., enterprise data exchange) environment in which different organizations can distribute, source, exchange, share and commercialize data and/or orchestrate data ecosystems. For example, organizations (e.g., enterprises) respectively associated with the server 210 and the servers 225 may distribute, source, exchange, and share configured sets of data. In an example, the server 210 may access or receive data sets such as worker data (e.g., worker attributes, worker scheduling information, etc.) and/or enterprise demand (e.g., demand for workers, for example, task data 272) associated with the organizations (e.g., enterprises) respectively corresponding to the servers 225. The data exchange platform may support the exchange (accessibility) of data among the server 210 and the servers 225, taking into account security, compliance, data policies, frameworks, and traceability associated with data exchanges. Servers 225 and the consortium 290 may include examples of aspects of like elements described with reference to FIG. 1.

### AHP Worker Ranking

Example aspects supportive of member ranking using an AHP matrix approach are described herein with reference to FIGS. 2 through 4.

FIG. 3 illustrates a system 300 including example data structures that support worker (e.g., employee, contractor) ranking in accordance with aspects of the present disclosure. The system 300 may be implemented by aspects of the system 100 or system 200 described with reference to FIGS. 1 and 2.

For example, the system 300 includes a composite worker ranker 305, a worker pairwise matrix 310, and a manager pairwise matrix 320. The composite worker ranker 305, the worker pairwise matrix 310, and the manager pairwise matrix 320 may be implemented, for example, by the server 110 or the server 210 (e.g., processor 250, memory 265, ranking manager 266-a, data model(s) 267) described herein with reference to FIGS. 1 and 2. In some other aspects, the composite worker ranker 305, the worker pairwise matrix 310, and the manager pairwise matrix 320 may be implemented by a communication device 105 or communication device 205 (e.g., processor 230, memory 240, application manager 241, data model(s) 242) described herein.

Referring to the system 300, multiple managers (e.g., supervisors) may each separately evaluate workers pairwise to create their own pairwise comparison matrix (PCM) (e.g., worker pairwise matrix 310). For example, each manager may evaluate workers included in a workforce based on worker data 315. The worker data 315 may include objective evaluation data (e.g., objective metrics, such as performance data 269-b described with reference to FIG. 2) and subjective evaluation data (e.g., subjective evaluations, such as assessment data 269-a described with reference to FIG. 2) associated with each worker included in the workforce. In some aspects, the worker data 315 may be stored on in a memory or database (e.g., a memory 240, a memory 265, a memory 285, and/or a database 215 described with reference to FIG. 2).

In some aspects, the worker data 315 may include entries (e.g., objective evaluation data, subjective evaluation data) input by a manager via a ranking application (e.g., ranking application 241-b described with reference to FIG. 2). In some other aspects, the worker data 315 may include objective evaluation data and/or subjective evaluation data extracted, recorded, aggregated, or calculated by a server (e.g., server 210 described with reference to FIG. 2, ranking manager 266-a) or a communication device (e.g., communication device 205 described with reference to FIG. 2).

In an example, each worker pairwise matrix 310 may include a set of matrix entries associated with the objective evaluation data, the subjective evaluation data, or both. In some cases, each worker pairwise matrix 310 may include side-by-side comparisons of workers with respect to any combination of objective metrics included in the objective evaluation data. In some other cases, each worker pairwise matrix 310 may include side-by-side comparisons of workers with respect to any combination of subjective evaluations included in the subjective evaluation data. In some aspects, for two or more different workers (e.g., ‘worker 1’ and ‘worker 2’), each worker pairwise matrix 310 may indicate a relationship (e.g., relative comparison) of the workers to one another.

In some aspects, the system 300 may support modifying one or more entries of the worker pairwise matrix 310. For example, in some AHP matrix approaches, some matrix entries may be left unfilled due to a level of uncertainty with respect to a subjective assessment (e.g., subjective evaluation). In some aspects, the system 300 may support modifying one or more unspecified entries and/or one or more specified entries of the set of matrix entries.

For example, the system 300 (e.g., by a server 110 or a ranking manager 111) may identify missing pairwise entries included in a manager's worker pairwise matrix 310. The system 300 may support automatically modifying the manager's worker pairwise matrix 310 to account for the missing pairwise entries. In some aspects, the system 300 may support modifying the manager's worker pairwise matrix 310 based on a ratio associated with completing all pairwise entries (e.g., 100% completeness).

In some examples, the quantity of matrix entries in the worker pairwise matrix 310 may be user defined (e.g., based on user choice of how many entries in the worker pairwise matrix 310 that the user is willing to make). In some aspects, the server 110 may modify specified and/or unspecified entries based on a user preference (e.g., whether modifications should occur in the specified or unspecified entries). Examples of modifying one or more entries (e.g., unspecified entries, specified entries, both) of the worker pairwise matrix 310 are described herein.

In a first example of modifying entries of the worker pairwise matrix 310, the server 110 (e.g., ranking manager 111) may insert a ‘1’ into all unspecified entries included in the worker pairwise matrix 310. With respect to any already-specified PCM entries included in the worker pairwise matrix 310, the server 110 may attempt to only modify a relatively small quantity (e.g., below a threshold, for example, a few) of the already-specified PCM entries in order to improve consistency of the resulting worker pairwise matrix 310 with respect to a threshold. For example, the server 110 (e.g., ranking manager 111) may modify a relatively small quantity of the already-specified PCM entries such that a consistency ratio (CR) associated with modifying the worker pairwise matrix 310 satisfies a threshold (e.g., CR≤0.1). The ranking manager 111 may examine entries of the PCM (e.g., worker pairwise matrix 310) for inconsistency based on a set of criteria.

In a second example of modifying entries of the worker pairwise matrix 310, the server 110 (e.g., ranking manager 111) may insert a ‘1’ into all unspecified entries included in the worker pairwise matrix 310. After inserting a ‘1’ into all unspecified entries, the server 110 may apply a matrix projection to a “closest” consistent matrix. Because of the matrix projection, the server 110 may potentially modify all of the PCM entries included in the worker pairwise matrix 310, which contrasts the approach of the first example in which a relatively small quantity of the already-specified PCM entries are modified.

In a variation of the second example of modifying entries of the worker pairwise matrix 310, the system 300 may support a user-selected convex combination of an original PCM (e.g., the worker pairwise matrix 310 prior to modification of one or more entries) and a projected PCM based on the original PCM. In an example, the server 110 (e.g., ranking manager 111) may modify the worker pairwise matrix 310 such that a CR associated with modifying the worker pairwise matrix 310 satisfies a threshold (e.g., CR<0.1, but within a threshold range from 0.1). In some aspects, the variation of the second example may include a relatively lesser modification to the worker pairwise matrix 310.

In a third example of modifying entries of the worker pairwise matrix 310, the server 110 (e.g., ranking manager 111) may maintain all specified entries included in the worker pairwise matrix 310. For example, the server 110 may indicate all specified entries as sacrosanct (i.e., not subject to change). Accordingly, for example, the server 110 may direct or restrict the modifications of entries of the worker pairwise matrix 310 to unspecified entries, while refraining from modifying all specified entries. In some cases, the server 110 may modify the worker pairwise matrix 310 with respect to a target CR, without modifying any specified entries of the worker pairwise matrix 310. For example, the server 110 may modify the worker pairwise matrix 310 such that a CR associated with modifying the worker pairwise matrix 310 is as close to satisfying a threshold (e.g., as close as possible to achieving a consistent matrix), without modifying any specified entries of the worker pairwise matrix 310.

In some aspects, the set of matrix entries included in the worker pairwise matrix 310 may be relative value judgments of criteria (e.g., objective metrics, subjective evaluations). For example, for matrix entries associated with two or more different workers (e.g., ‘worker 1’ and ‘worker 2’), value judgments associated with ‘worker 1’ may be relative to value judgements associated with ‘worker 2.’

The system 300 may support generating composite evaluation data based on the relative value judgements included in the worker pairwise matrix 310. For example, the system 300 may support converting (e.g., by the server 110, by the ranking manager 111) a first set of values included in the worker pairwise matrix 310 into composite evaluation data. In an example, the first set of values are relative values (e.g., relative value judgments of criteria, relative worker rankings). In some aspects, values included in the composite evaluation data are absolute values (e.g., a linear list of absolute value judgments, a linear ordering or ranking of the workers).

In some aspects, the server 110 (e.g., ranking manager 111, composite worker ranker 305) may apply AHP techniques described herein to the worker pairwise matrices 310 to convert the relative value judgements to composite evaluation data (e.g., worker ranking information 335). The worker ranking information 335 may be referred to as worker ranking data, composite evaluation data, or composite worker rankings. For example, for each worker pairwise matrix 310 associated with a manager, the server may apply AHP to convert relative worker rankings in the worker pairwise matrix 310 to a total ordering of workers (e.g., a ranking order).

In an example of applying AHP to a worker pairwise matrix 310, the server 110 (e.g., ranking manager 111) may enter the relative judgments of the worker pairwise matrix 310 into a square positive reciprocal matrix. In an example, rows and columns of the square positive reciprocal matrix may include the relative judgment ratios for pair-wise comparisons of indicator values. For example, the relative judgement ratios may correspond to pair-wise comparisons of value judgments associated with ‘worker 1’ to value judgements associated with ‘worker 2.’

In some aspects, such a square positive reciprocal matrix is guaranteed to have a maximal eigenvalue which is positive and whose corresponding eigenvector is composed of positive entries. Moreover, this maximal eigenvalue is related to a measure of consistency for the matrix of pairwise judgements. In some aspects, the system 300 may support revisiting or reevaluating the entries to obtain a higher overall consistency. In some cases, AHP may support multiple levels of prioritization.

The system 300 may support group decision making based on the respective PCMs (e.g., worker pairwise matrices 310) associated with the managers. For example, the system 300 may support the aggregation of individual numerical judgements and rankings, obtained from individual AHP judgements, of N judges (e.g., managers). In some aspects, the system 300 (e.g., server, ranking manager 266-a) may synthesize and/or aggregate numerical judgements from N judges based on satisfying a set of criteria or parameters. In some examples, the system 300 may support applying weighting factors to the managers and/or judgements and rankings provided by the managers.

For example, the system 300 may support synthesizing and/or aggregating numerical judgements from multiple managers (i.e., N judges) based on satisfying a function ƒ with respect to conditions of separability, weighted separability, unanimity, homogeneity, and/or power conditions. For example, a function ƒ: P→J for synthesizing numerical judgements from N judges should satisfy the following conditions, where P & J are intervals of positive numbers and ƒ is continuous, associative and cancellative:
1. Separability (S): ƒ(x₁, x₂, . . . , x_{N})=g(x₁)g (x₂) . . . g(x_{N}) where x₁, x₂, . . . , x_{N}∈P and g(x₁), g (x₂), . . . g(x_{N})∈J i the synthesized decision ƒ is represented as the product of some function g of the individual decisions.
2. Weighted Separability (WS): ƒ(x₁, x₂, . . . , x_{N})=g₁g(x₁)q₂g(x₂) . . . q_{N}g(x_{N}) i.e. allowing for different positive weightings of individual judge's decisions, and where q₁+q₂+ . . . +q_{N}=1 and qₖ>0.
3. Unanimity (U): ƒ(x, x, . . . x)=x i.e. unanimous decisions among judges should be synthesized as that same decision.
4. Homogeneity (H): ƒ(μx₁, μx₂, . . . , μx_{N})=μƒ(x₁, x₂, . . . , x_{N}) i.e. same scale factor applied to all decisions is reflected as that same scale factor times the synthesized decision.
5. Power conditions (P): ƒ(x₁^{p}, x₂^{p}, . . . , x_{N}^{p})=ƒ^{p}(x₁, x₂, . . . , x_{N}) i.e. the synthesis of the same power p of the individual decisions is the same power p of the synthesized decision.
   Important special case (R):

$$f ( \frac{1}{{x}_{1}} , \frac{1}{{x}_{2}} , … , \frac{1}{{x}_{N}} ) = \frac{1}{f ( {x}_{1} , {x}_{2} , … , {x}_{N} )}$$

i.e., judgements of values must be combined so that the reciprocal of the synthesized judgement must equal the synthesis of the reciprocals of the individual judgements.

In an example, upper management (e.g., a higher level manager(s)) may evaluate the managers pairwise to create another PCM (e.g., manager pairwise matrix 320, or multiple manager pairwise matrices 320). For example, upper management may evaluate the managers based on manager data 325. In an example, upper management may evaluate workers using a ranking application 106 at a communication device 105 described herein. In some aspects, the evaluation may be autonomously or semi-autonomously (e.g., based on user inputs by upper management) performed by the ranking application 106.

The manager data 325 may include objective evaluation data (e.g., objective metrics, such as performance data 269-b described with reference to FIG. 2) and subjective evaluation data (e.g., subjective evaluations, such as assessment data 269-a described with reference to FIG. 2) associated with each manager. In some aspects, the manager data 325 may be stored on in a memory or database (e.g., a memory 240, a memory 265, a memory 285, and/or a database 215 described with reference to FIG. 2).

In some aspects, the manager data 325 may include entries (e.g., objective evaluation data, subjective evaluation data) input by upper management 330 via the ranking application 106. In some other aspects, the manager data 325 may include objective evaluation data and/or subjective evaluation data extracted, recorded, aggregated, or calculated by a server 110 (e.g., ranking manager 111) or a communication device 105 (e.g., an application manager).

In an example, a manager pairwise matrix 320 may include a set of matrix entries associated with the objective evaluation data, the subjective evaluation data, or both. In some cases, the manager pairwise matrix 320 may include side-by-side comparisons of managers with respect to any combination of objective metrics included in the objective evaluation data. In some other cases, the manager pairwise matrix 320 may include side-by-side comparisons of workers with respect to any combination of subjective evaluations included in the subjective evaluation data. In some aspects, for two or more different managers (e.g., ‘manager 1’ and ‘manager 2’), the manager pairwise matrix 320 may indicate a relationship (e.g., relative comparison) of the managers to one another.

In some aspects, the system 300 may support modifying one or more matrix entries of the manager pairwise matrix 320. For example, the system 300 may support modifying one or more unspecified entries and/or one or more specified entries in the manager pairwise matrix 320. For example, the system 300 (e.g., by a server 110 or a ranking manager 111) may identify missing pairwise entries included in an upper manager's manager pairwise matrix 320. The system 300 may support automatically modifying the upper manager's manager pairwise matrix 320 to account for the missing pairwise entries. In some aspects, the system 300 may support modifying the upper manager's manager pairwise matrix 320 based on a ratio associated with completing all pairwise entries (e.g., 100% completeness).

Aspects of modifying unspecified entries and/or one or more specified entries in the manager pairwise matrix 320 may be implemented by example aspects described herein for modifying one or more entries (e.g., unspecified entries, specified entries, both) of the worker pairwise matrix 310.

The system 300 may support generating weighting information associated with the managers based on the relative value judgements included in the manager pairwise matrix 320. In an example, the system 300 may support applying (e.g., by a server 110, by a ranking manager 111) AHP on the manager pairwise matrix 320 to calculate a total ordering of managers' relative weights. In an example, the server 110 may incorporate the total ordering of managers' relative weights in the composite worker ranking process.

In an example of the composite worker ranking process, the server 110 (e.g., composite worker ranker 305) may generate the worker ranking information 335 based on the total ordering of manager's relative weights in combination with the data included in the worker pairwise matrices 310. The worker ranking information 335 may include composite worker rankings associated with the workers (e.g., a ranking order). In another example, the server 110 (e.g., composite worker ranker 305) may generate the worker ranking information 335 (e.g., composite worker rankings) based on weighted geometric mean or a root-mean-powers.

For example, the system 300 may support determining (e.g., by a server, a ranking manager 266-a) a geometric mean when synthesizing individual judgements (e.g., subjective evaluations by different managers, worker pairwise matrices 310 associated with the different managers, etc.) using AHP. The geometric mean may be, for example, a weighted geometric mean. In another example, the system 300 may support determining a root-mean-powers when synthesizing the individual judgements using AHP. The root-mean-powers may be, for example, a weighted root-mean-powers.

Accordingly, for example, the system 300 may support upper managers imposing relative weightings on the evaluations of lower level managers. In an example, the weighted generalized geometric mean may be used to form composite worker evaluations. In some cases, such imposing of relative weightings by upper managers may be applicable within a retail environment for a common brand (e.g., corporate-level managers evaluating individual store managers of the same brand).

Example aspects of synthesizing aggregating numerical judgements from multiple managers when using AHP (in which a function ƒ is a geometric mean or a root-mean-power), in combination with the application thereof to generating the worker ranking information 335 (e.g., composite evaluation data), are described with reference to FIG. 4.

FIG. 4 illustrates an example of a process flow 400 that supports worker (e.g., employee, manager, contractor) ranking in accordance with aspects of the present disclosure. In some examples, process flow 400 may implement aspects of system 100, system 200, or system 300 described with reference to FIGS. 1 through 3. For example, aspects of the process flow 400 may be implemented by a server 110, a server 210 (e.g., processor 250, memory 265, ranking manager 266-a, data model(s) 267, a communication device 105, a communication device 205 (e.g., processor 230, memory 240, application manager 241, data model(s) 242), or a composite worker ranker 305 described herein.

In the following description of the process flow 400, the operations may be performed in a different order than the order shown, or the operations may be performed in different orders or at different times. Certain operations may also be left out of the process flow 400, or other operations may be added to the process flow 400.

It is to be understood that while various devices (e.g., a communication device 105, a server 110) of the system 100 are described as performing a number of the operations of process flow 400, any device of the system 100 may perform the operations shown.

At 405, multiple managers (e.g., supervisors) may each separately evaluate workers pairwise to create their own PCM (e.g., a worker pairwise matrix 310 described with reference to FIG. 3). In an example, each manager may evaluate workers using a ranking application 106 at a communication device 105 described herein.

At 410, the system 100 (e.g., by a server 110 or a ranking manager 111) may identify missing pairwise entries included in a manager's PCM. In an example, at 410, the system 100 may automatically modify each manager's PCM to account for the missing pairwise entries.

At 415, the server 110 may apply AHP techniques described herein to the manager PCMs to convert relative value judgements to composite evaluation data (e.g., worker ranking information). The worker ranking information may be referred to as worker ranking data. For example, at 415, for each PCM associated with a manager, the server may apply AHP to convert relative worker rankings in the PCM to a total ordering of workers (e.g., a ranking order).

At 420, upper management (e.g., a higher level manager(s)) may evaluate the managers pairwise to create another PCM (e.g., a manager pairwise matrix 320 described with reference to FIG. 3). In an example, at 420, upper management may evaluate workers using a ranking application 106 at a communication device 105 described herein. In some aspects, the evaluation may be autonomously or semi-autonomously (e.g., based on user inputs by upper management) performed by the ranking application 106 and/or the ranking manager 111.

At 425, the server 110 (e.g., ranking manager 111) may identify missing pairwise entries included in an upper manager's PCM. For example, at 425, the server 110 or ranking manager 111 may automatically modify the upper manager's PCM to account for the missing pairwise entries.

At 430, the server 110 (e.g., ranking manager 111) may apply AHP on the upper manager's PCM to calculate a total ordering of managers' relative weights. In an example, the server 110 (e.g., ranking manager 111) may incorporate the total ordering of managers' relative weights in the composite worker ranking process.

At 435, the server 110 (e.g., ranking manager 111) may generate worker ranking information based on the total ordering of manager's relative weights in combination with the data included in the managers' PCMs. The worker ranking information may include composite worker rankings associated with the workers (e.g., a ranking order). In another example, at 435, the server 110 (e.g., ranking manager 111) may generate or create the worker ranking composite worker rankings based on weighted geometric mean or a root-mean-powers.

In some aspects, the server 110 (e.g., scheduling manager 112) may apply the composite worker rankings as an input to an objective function when establishing or setting a proposed work schedule. In some aspects, the server 110 may determine a proposed work schedule that minimizes the objective function subject to a set of parameters or constraints. In some examples, the objective function may be parameterized to provide varying weights to different criteria in the scheduling process.

In an example, the set of parameters associated with minimizing the objective function may include aspects of example Parts I through VII described herein. Aspects of applying the parameters when determining a proposed work schedule are later described with reference to FIG. 5.

Part I may include accommodating worker temporal preferences (e.g., time-slot preferences) when allocating time-slots to workers. In an example, the time-slot preferences may be indicated as preference scores in a PCM (e.g., a worker pairwise matrix 310 described with reference to FIG. 3). In some aspects, the server 110 (e.g., ranking manager 111) may modulate the preference scores based on worker evaluation scores generated via AHP. For example, the server 110 may modulate the preference scores based on the composite evaluation data (e.g., worker ranking information, worker ordering) determined at 415.

In some aspects of accommodating worker time-slot preferences, the server 110 may retain each worker's evaluation score (e.g., ranking determined at 415, composite worker ranking determined at 435) on a per-store basis. In an example, for a ‘worker 1’ and a ‘store 1,’ the server 110 may modulate the time-slot preferences of ‘worker 1’ for ‘store 1’ by the evaluation score (e.g., ranking, composite worker ranking) associated with ‘worker 1’ and ‘store 1.’ In some aspects, the server 110 may normalize each worker's evaluation score on a per-store basis. For example, for a given store, the server 110 may normalize the evaluation scores of all workers of the store such that the sum of the evaluation scores is equal to 1.

In an example of accommodating worker time-slot preferences, a modified and corrected extended objective function for minimization may be represented by the following equation:

$$α [ {\sum }_{k = 1}^{L} {\sum }_{i = 1}^{{N}_{k}} {[ {d}_{ik} - {\sum }_{j = 1}^{{M}_{k}} {f}_{jk} {x}_{ijk} ]}^{2} ] + β {\sum }_{k = 1}^{L} {\sum }_{i = 1}^{{N}_{k}} {\sum }_{j = 1}^{{M}_{k}} {{e}_{jk} ( {x}_{ijk} - {γ}_{ijk} )}^{2} + ( 1 - α - β ) {\sum }_{k = 1}^{L} {\sum }_{j = 1}^{{M}_{k}} {e}_{jk} {S}_{{j}_{k}}$$

Referring to the equation:
0<α+β<1, α, β non-negative weighting parameters for trading-off the terms involving filling time-slots, accommodating worker time-slot preferences, and penalizing split shifts:
α→term involving filling the labor demand for time-slots;
β→term involving accommodating worker time-slot preferences; and
(1−α−β)→term involving penalizing split shifts, but restricted to involve only high-value workers as indicated by the j*∈J* indicating the set of high-value workers.

In some aspects, a may have a relatively higher weight compared to (e.g., greatly dominate) the terms β and (1−α−β). For example, criteria associated with the labor demand may be that the labor demand is always satisfied or close-to being satisfied (e.g., within a threshold).
L=total number of stores being scheduled
Nₖ=number of time-slots for store k
Mₖ=number of workers in store k
Sⱼₖ=number of split shifts of worker j within store k
xᵢⱼₖ=binary 0-1 variable for assigning worker j to time interval i within store k
dᵢₖ=labor demand for time-interval i within store k
eⱼₖ=evaluation score for worker j within store k, subject to Σⱼ₌₁^{M}^{ₖ} eⱼₖ=1 for each store k
ƒⱼₖ=capability fraction of labor demand dᵢₖ represented by worker j within store k. In an example, dᵢₖ=3, and worker j may represent ½ or ⅓ of the labor demand dᵢₖ for store k. In some aspects, the demand dᵢₖ may be satisfied by different combinations of workers having different capabilities (e.g., three medium-capability workers, or two high-capability workers).

Aspects of the capability fraction ƒⱼₖ may be applied to a delivery application (e.g., in Part V described herein). For example, the capability fraction ƒⱼₖ may be extended to ƒᵢⱼₖ for incorporating time-slot-dependent capabilities (e.g., store openers and closers).

Yᵢⱼₖ=binary 0-1 variable for worker j's preference for time-slot i for store k.

Part II may include specifying or configuring temporal parameters associated with allocating time-slots. For example, Part II may include conditions such as a maximum quantity of split-shifts per worker per day (e.g., a maximum of two split-shifts per worker per day), a maximum of 12 (configurable) hours per day, a maximum of 37.5 (configurable) hours per week, a minimum of 3 hours per shift, a minimum of 2 hours between shifts (e.g., in the case of split-shifts), and a maximum of 5 (configurable) working days per week.

In some aspects, for assigning a split-shift (e.g., multiple shifts separated by a temporal duration) on a given day, Part II may include a condition that the second shift is to be at the same store as the first shift. In some aspects, this condition may be relaxed in some cases (e.g., as described in Part V). In some other aspects, Part II may include a condition that the quantity of split-shifts per worker per day (e.g., across all stores) does not exceed 1.

Part III may include techniques for automatically accommodating, via a soft constraint, cases in which satisfying a condition associated with Part II (e.g., a maximum of 37.5 (configurable) hours per week per worker) would result in an open time-slot (or work shift) that is not allocated to any worker. For example, Part III supports the assignment of one or more workers to fill the open time-slot (or portions of the open time-slot), even if such assignment results in a worker(s) exceeding the maximum of 37.5 hours per week. In some aspects, Part III may include a further condition (e.g., a hard constraint) specifying a maximum of 40 (configurable) hours per week per worker, for example, for a worker(s) assigned to fill the open time-slot. In an example, a weight associated with exceeding the maximum of 37.5 hours per week per worker may be relatively less than a weight associated with accommodating labor demands for all time-slots of a schedule.

Part IV may include conditions and formulations supportive of working a split-shift at different stores. For example, the first shift and the second shift assigned to a worker may be at different stores.

Part V may include techniques associated with addressing cases of multiple workstations or task types associated with a time-slot. For example, Part V may incorporate scheduling workers of different worker types to time-slots (without assigning workers to specified workstations or work tasks), followed by assigning the scheduled workers to workstations or work tasks associated with the assigned time-slots. For example, Part V may incorporate considering worker type (e.g., managers, indoor workers, delivery drivers, etc.) and task type when scheduling shifts.

In an example, Part V may include a two-step process in which the first step includes allocating workers to time-slots via the techniques described herein for scheduling shifts, thus allocating workers to time-slots but not yet assigning them to the multiple workstations. In the second step, for example, a Lagrange relaxation method is used within each time-slot to assign the workers to workstations associated with the time-slots.

In an example case of delivery services, the number of worker types may be set to 3 (e.g., managers, indoor workers, and delivery drivers). In some aspects, the separation of tasks by worker type (e.g., category) may provide advantages for separately scheduling shifts that do not overlap by category.

In another example, the category for ‘indoor worker’ may have multiple sub-categories to be scheduled. Aspects of Part V may support adaptive reassignment (e.g., by a manager in real-time, autonomously or semi-autonomously by a scheduling manager 112 in real-time, etc.) of workers to tasks, workstations, or sub-categories of the workstations during a work shift. In an example, the sub-categories may be defined according to store, brand, etc. In some aspects, all or a portion of the sub-categories may be the same between stores, brands, etc. In some aspects, a worker type (e.g., a manager) may be assignable to work any sub-category associated with ‘indoor workers.’

In another example, Part V may accommodate individual worker's capability factors (e.g., a worker qualified to open or close a store, workers unqualified to open or close the store). For example, the capability factor, ƒⱼₖ described herein may be generalized to be ƒᵢⱼₖ to include time-slot indices i (e.g., adding time-slots as a parameter). For example, opening and closing a store may be work tasks to be completed at the beginning and end of a workday. In some aspects, when scheduling workers for a work task (e.g., opening or closing a store), the corresponding ƒᵢⱼₖ for a worker who is not qualified for the work task (e.g., not capable of the work task, not approved for the work task by a manager) would equal ‘0’ for any time-slots (e.g., closing times, opening times) associated with the work task.

In some other examples, Part V may accommodate store-specific conditions. For example, a condition specific to a store may specify that no ‘indoor workers’ are to be scheduled for time-slot that occurs prior to a target time (e.g., 4 PM) on any day. For example, the condition may imply that a manager (e.g., not other worker types) is needed in the time-slots which occur prior to the target time.

An example of the two-step process (also referred to herein as a two-stage process) associated with Part V is described herein. Some scheduling cases may exist in which the separability described herein (e.g., scheduling based on worker type, task type, workstation, or associated sub-categories) does not hold or may not be implemented. Part V may include scheduling techniques for determining scheduled shifts for workers, while evaluating the possibility that although the workers are scheduled to shifts, one or more of the workers scheduled for a shift may change roles within time-slots associated with the shift. In some aspects, the server 110 (e.g., scheduling application 107) may support algorithmically scheduling workers to different roles within the time-slots.

In an example, the server 110 (e.g., scheduling manager 112) or a communication device 105 (e.g., scheduling application 107) may change or modify scheduled sub-category assignments from time-slot to time-slot based on changes or modifications to the type of workstations from time-slot to time-slot. For such example cases, the server 110 may generalize the capability factor ƒⱼₖ for each worker to accommodate multiple corresponding capabilities for multiple workstation tasks. In an example, the total demand for all workstations within a time-slot may be equal to the sum of the demands for each workstation within the time-slot.

In an example of the first stage of the two-stage process, the server 110 (e.g., scheduling manager 112) may schedule worker shifts using the same objective function described herein with respect to worker scheduling. For the first stage (e.g., with respect to shift scheduling), the capabilities {ƒⱼₖ} of each worker j may be set as equal to

$$\frac{1}{{d}_{i}} ,$$

where dᵢ=Σₘ₌₁^{M}^{ᵢ} dᵢₘ and Mᵢ=number of workstations in a time-slot i. In some aspects, this assumption with respect to worker capabilities and workstations may support computational tractability.

In an example of the second stage of the two-stage process, the server 110 (e.g., scheduling manager 112) may match the scheduled shift workers to the multiple workstation demands within a time-slot. In some aspects, matching the scheduled shift workers to the multiple workstation demands may be treated as an assignment problem (as opposed to a scheduling problem since time is not involved). For the second stage, the server 110 may generalize the capability factors {ƒⱼₖ} for each worker j associated with a store k as ƒᵢₖₘ, reflecting a worker's capabilities for any of the multiple workstation tasks m within the time-slot i.

In some examples, the system 100 may support treating the matching of scheduled shift workers to multiple workstation demands as an assignment problem inclusive of aspects of a weapon-to-target assignment (WTA) problem. In an example of WTA, the workers may be analogous to weapons, and the workstations may be analogous to targets. The server 110 (e.g., scheduling manager 112) may calculate the probabilities of kill for each worker j at store k and workstation m as

$$\frac{{f}_{jkm}}{{\sum }_{j = 1}^{{M}_{k}} {f}_{jkm}} .$$

The relative importance of the workstations may be analogous to the intrinsic value of each target in a WTA approach.

In some aspects, the system 100 (e.g., server 110, scheduling manager 112) may support a Lagrange relaxation approach to matching of scheduled shift workers to multiple workstation demands. For example, the Lagrange relaxation approach may incorporate probabilities of kill on targets of having differing intrinsic values. For example, the Lagrange relaxation approach may include two parts: a first part which leads to a tractable one-dimensional search, and a second part which leads to a linear programming problem having a guaranteed integer solution (e.g., because of the total unimodularity of the constraint matrix).

Example definitions of terms associated with applying WTA to multi-station assignment are described herein:
W: Number of different weapons types
T: Number of targets to be engaged
uⱼ: value of target j
wᵢ: number of weapons of type i
tⱼ: minimum number of weapons needed for target j
pᵢⱼ: probability of kill for target j by weapon i
xᵢⱼ: integer decision variable indicating number of weapons of type i assigned to
target j

In an example of assigning workers to multiple stations based on WTA, a multi-station position j would be analogous to a target/. In some aspects, the system 100 (e.g., server 110, scheduling manager 112) may support ignoring weapon types (e.g., worker types) for such multi-station assignments. For example, the number of different weapons types, W, may be equal to ‘1,’ and the number of weapons of type i may be equal the total number of weapons (i.e., Σᵢ₌₁^{w} wᵢ). Accordingly, for example, the server 110 (e.g., scheduling manager 112) may refrain from making distinctions among available workers for the multi-station assignments. The server 110 may distinguish between available workers based on respective worker classes. For example, the server 110 may distinguish between available workers based on criteria such as seniority, proficiency, or other configurable categories, in which case W>1.

In an example, the number of targets to be engaged, T, may be analogous to the number of multi-station assignments within the given fixed time interval (e.g., 15 minute time-slots). In another example, the relative values of the targets, uⱼ, may be analogous to the relative importance or operational criticality among the multi-station assignments. In some aspects, all targets uⱼ may have the same utility. In some examples, the minimum number of weapons, t₁, for any target j may be analogous to the labor demand for the corresponding multi-station assignment j.

The probability of kill, pᵢⱼ, for any target j by a weapon of type i may be modeled as:

$$\frac{{f}_{pqr}}{{\sum }_{p , q , r} f} ,$$

where ƒ_{pqr} is a capability factor for a worker for incorporating time-slot-dependent capabilities (e.g., capabilities such as store openers and closers). In an example, p refers to the fixed time interval, q refers to the worker, and r denotes the store. The capability factor may include aspects of the capability factor ƒⱼₖ described herein.

In an example, the integer decision variable xᵢⱼ, indicating number of weapons of type i assigned to target j, may be analogous to the assignment of worker i to multi-station position j within the fixed time interval.

Part VI may include techniques for incorporating historical scheduling information (e.g., prior scheduling history) as a soft constraint in the objective function into upcoming schedules.

An example with respect to Part VI is described. Part VI may include determining upcoming schedules (e.g., scheduling information) on a daily basis, based on a scheduling history. For example, with respect to the equation below corresponding to an objective function term D, S₁ and S₂ may be daily schedules set apart by a temporal duration (e.g., 1 week of 2 weeks apart), where S₁ is the new schedule for a given day, and S₂ is a previous schedule for that day.

In some aspects, incorporating past schedule history may include applying (e.g., by the server 110, by the scheduling manager 112) penalty function terms in the objective function. The penalty function terms may support penalizing a worker for departures from (e.g., late arrivals, missing a scheduled shift, etc.) a previous schedule (e.g., one or more of the previous two schedules).

In an example, the objective function term D may be associated with incorporating past schedules (e.g., from the week prior and from two weeks prior) and may be represented as:

D=[δd(Sₚᵣₑₛₑₙₜ,S_{pastweek})+(1−δ)d(Sₚᵣₑₛₑₙₜ,S_{2weekspast})]

Part VII may include techniques for incorporating historical scheduling information (e.g., prior scheduling history) as a soft constraint in the objective function into determining upcoming schedules (e.g., future schedules). For example, Part VII may include techniques for taking into account past schedules using integer time-series predictions for start and stop times of worker shifts.

In an example, based on aspects of Part VII, the system 100 (e.g., server 110, scheduling manager 112) may support using relatively longer scheduling histories (e.g., from three or more weeks prior) compared to those used in Part VI for prediction. In some aspects, based on Part VII, the system 100 may support incorporating relatively longer correlation scales compared to the techniques described with reference to Part VI. In an example, the server 110 (e.g., scheduling manager 112) may apply schedules predicted according to the techniques of Part VII as starting solutions for the objective function minimization process.

In some aspects, Part VII may incorporate one or more prediction methods including statistical methods such as autoregressive (AR), moving average (MA), and ARMA. In some examples, Part VII may incorporate AI techniques such as long short-term memories (LSTMs). In some aspects, Part VII may include non-standard time-series prediction methods designed for integer time-series.

FIG. 5 illustrates an example of a process flow 500 that supports worker scheduling and worker assignments in accordance with aspects of the present disclosure. In some examples, process flow 500 may implement aspects of system 100, system 200, or system 300 described with reference to FIGS. 1 through 3. For example, aspects of the process flow 500 may be implemented by a server 110, a server 210 (e.g., processor 250, memory 265, ranking manager 266-a, data model(s) 267), a communication device 105, or a communication device 205 (e.g., processor 230, memory 240, application manager 241, data model(s) 242) described herein.

In the following description of the process flow 500, the operations may be performed in a different order than the order shown, or the operations may be performed in different orders or at different times. Certain operations may also be left out of the process flow 500, or other operations may be added to the process flow 500. It is to be understood that while various devices (e.g., a communication device 105, a server 110) of the system 100 are described as performing a number of the operations of process flow 500, any device of the system 100 may perform the operations shown.

Process flow 500 may implement example aspects of Parts I through VII of the objective function described herein.

At 505, a server 110 (e.g., scheduling manager 112) may apply integer time-series predictions and recurrent neural net predictions for determining starting windows associated with start/stop times of worker shifts. In some aspects, 505 may include applying an integer programming algorithm (also referred to herein as a scheduling integer programming algorithm).

At 510, the server 110 may determine windows for start/stop time starting solutions for potential work shifts in the scheduling integer programming algorithm.

At 515, the server 110 may apply determine or identify a shift scheduling objective function.

At 520, the server 110 may apply a constraint integer programming satisfiability and optimization algorithm.

At 525, the server 110 may determine a worker-to-workstation assignment(s) within fixed-time intervals within overlapping shifts.

At 530, the server 110 may identify or output candidate worker shift schedules (e.g., a proposed work schedule including a set of proposed work shifts)

At 535, the server 110 may determine worker shifts. In some aspects, at 535, the server 110 may determine worker assignments with respect to candidate workstations within the shifts.

### Dynamic and Iterative Scheduling of Workers

FIG. 6 illustrates an example process flow 600 that support worker scheduling (e.g., dynamic and iterative scheduling of workers) in accordance with aspects of the present disclosure. In some examples, process flow 600 may implement aspects of system 100, system 200, or system 300 described with reference to FIGS. 1 through 3. For example, aspects of the process flow 600 may be implemented by a server 110, a server 210 (e.g., processor 250, memory 265, ranking manager 266-a, data model(s) 267), a communication device 105, or a communication device 205 (e.g., processor 230, memory 240, application manager 241, data model(s) 242) described herein.

The process flow 600 of FIG. 6, for example, illustrates an example of iterative scheduling of workers (also referred to herein as dynamic proposed scheduling).

In the following description of the process flow 600, the operations may be performed in a different order than the order shown, or the operations may be performed in different orders or at different times. Certain operations may also be left out of the process flow 600, or other operations may be added to the process flow 600. It is to be understood that while various devices (e.g., a communication device 105, a server 110) of the system 100 are described as performing a number of the operations of process flow 600, any device of the system 100 may perform the operations shown.

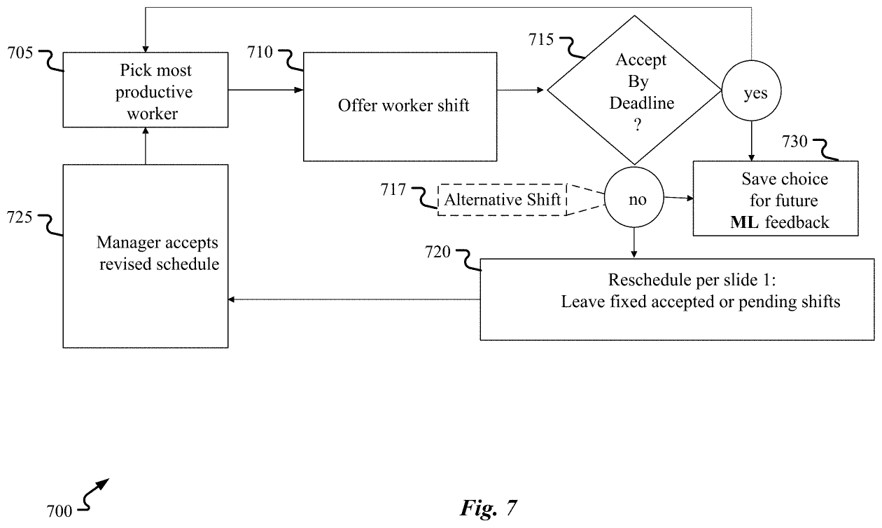

At 605-a, a server 110 (e.g., scheduling manager 112) may identify a first set of parameters (constraints 1′) associated with a scheduling period for assigning workers to a work schedule corresponding to a future time period (e.g., the next week). In some aspects, the scheduling period may be set autonomously by the server 110 (e.g., based on the parameters). In some other aspects, the scheduling period may be set semi-autonomously (e.g., based on inputs by a manager, based on manager settings or preferences). Example mathematical algorithms, formulas, and parameters are described following the descriptions of FIGS. 6 and 7.

In an example, the server 110 may set or fix a scheduling start time and a scheduling end time of the scheduling period such that the scheduling period is equal to one week. In another example, the scheduling period may begin on a Tuesday at 12 noon (“scheduling start”) and end on a Saturday at 12 noon (“scheduling end”). An example objective associated with ‘constraints 1’ may be that by “scheduling end,” a complete and final schedule is confirmed for some future time period (e.g. the next week)

At 610-a, the server 110 (e.g., scheduling manager 112) may output a proposed schedule. In some aspects, the proposed schedule may be a partial proposed schedule (also referred to herein as an initial proposed schedule or ‘proposed partial schedule 1’). In an example, the server 110 may output the proposed schedule at a temporal instance corresponding to a “scheduling start.”

At 615-a, the server 110 (e.g., scheduling manager 112) may implement a worker acceptance algorithm, via which the server 110 may offer work shifts to workers and process worker responses to the offered work shifts. In some aspects, the server 110 may offer work shifts to the workers based on a priority order associated with the workers. In an example, the server 110 may offer work shifts based on composite evaluation data (e.g., composite worker rankings) described herein. For example, the server 110 may offer work shifts included in the proposed schedule 610-a, starting with the most productive worker(s). An example algorithm for offering work shifts at 615-a is described with reference to FIG. 7.

In some aspects, the server 110 may offer work shifts over multiple scheduling passes or iterations. For example, the server 110 may continue to offer work shifts until all work shifts have been accepted by a worker. Aspects of the scheduling passes or iterations are described with reference to FIG. 7.

In some other aspects, if a worker rejects a proposed shift included in the ‘proposed partial schedule 1’ (or fails to respond to the proposed shift within a response duration), the server 110 may re-run the scheduling algorithm described herein to fill the rejected shift (e.g., offer the rejected shift to a different worker).

For example, at 605-b, the server 110 (e.g., scheduling manager 112) may identify a second set of parameters (constraints 2′) associated with the scheduling period described with reference to 605-a.

At 610-b, the server 110 (e.g., scheduling manager 112) may output another proposed schedule (also referred to herein as ‘proposed partial schedule 2’). In an example, ‘proposed partial schedule 2’ may be a revised schedule compared to ‘proposed partial schedule 1.’ In an example, ‘proposed partial schedule 2’ may include the rejected shift associated with ‘proposed partial schedule 1.’

In some aspects, when generating ‘proposed partial schedule 2,’ the server 110 (e.g., scheduling manager 112) may maintain any proposed shifts that have already been accepted by a worker and/or confirmed by the server 110 (also referred to herein as confirmed shift, an accepted shift, a filled shift, etc.). For example, the server 110 may refrain from modifying, reassigning, or offering a confirmed shift to another worker. In some other aspects, when generating ‘proposed partial schedule 2,’ the server 110 may maintain any proposed shifts for which a response is pending (e.g., a proposed shift for which a response duration has not expired). Alternatively, or additionally, when generating ‘proposed partial schedule 2,’ the server 110 may reschedule any workers for which a work shift has not yet been proposed (e.g., the server 110 has not transmitted a proposed work shift to the worker).

At 615-b, the server 110 (e.g., scheduling manager 112) may implement (e.g., re-run) the worker acceptance algorithm, via which the server 110 may offer work shifts to workers (e.g., based on ‘proposed partial schedule 2’) and process worker responses to the offered work shifts.

The server 110 may continue to schedule work shifts, offer work shifts, and process responses to work shifts until all work shifts have been accepted by a worker. For example, the server 110 may further identify parameters at 605-c, generate a ‘proposed partial schedule 3’ at 610-c, implement the worker acceptance algorithm at 615-c, identify parameters at 605-d (not shown), and so on.

In some aspects, the server 110 (e.g., scheduling manager 112) may continue to schedule work shifts, offer work shifts, and process responses to work shifts based on an objective or target parameter (e.g., an objective to have at least as much of the schedule finalized as has elapsed from the “scheduling start” to a “scheduling end.” For example, at a halfway point the “scheduling start” and the “scheduling end,” the objective may include a condition that at least half the schedule should be finalized (e.g., the hours associated with the confirmed work shifts should equal half of the total hours to be scheduled).

At 620, the server 110 (e.g., scheduling manager 112) may output a work schedule. The work schedule may be a partial or complete work schedule. In some aspects, the server 110 may output (and a manager may view, for example, via a scheduling application 107 on a communication device 105) a work schedule at any stage of the process flow 600. For example, a manager may view the work schedule in real-time. In an example, the manager may view the work schedule at any temporal instance during which the server 110 is generating a proposed partial schedule (e.g., at 610-a, 610-b, 610-c, etc.) or implementing the worker acceptance algorithm (e.g., at 615-a, 615-b, 615-c, etc.). In some aspects, a worker may view the work schedule (e.g., via a scheduling application 107) or portions thereof based on permissions or authorizations provided to the worker.

In some aspects, at 620, the server 110 (e.g., scheduling manager 112) may receive a response from the manager (e.g., via the scheduling application 107). In some examples, the response may be a manager approval (e.g., acceptance) of the schedule. In another example, if the response is a manager rejection of the schedule, the server 110 may modify any portion or the entirety of the work schedule based on the techniques described with respect to the process flow 600. In some aspects, the server 110 may modify the work schedule based on scheduling parameters (e.g., constraints) provided by the manager.

FIG. 7 illustrates an example of a process flow 700 that supports member scheduling in accordance with aspects of the present disclosure. In some examples, process flow 700 may implement aspects of system 100, system 200, or system 300 described with reference to FIGS. 1 through 3. For example, aspects of the process flow 600 may be implemented by a server 110, a server 210 (e.g., processor 250, memory 265, ranking manager 266-a, data model(s) 267), a communication device 105, or a communication device 205 (e.g., processor 230, memory 240, application manager 241, data model(s) 242) described herein.

The process flow 700 of FIG. 7, for example, illustrates an example of a worker acceptance algorithm associated with iterative scheduling of workers. For example, process flow 700 may be implemented at 615 (e.g., 615-a, 615-b, 615-c, etc.) described with reference to FIG. 6.

In the following description of the process flow 700, the operations may be performed in a different order than the order shown, or the operations may be performed in different orders or at different times. Certain operations may also be left out of the process flow 700, or other operations may be added to the process flow 700. It is to be understood that while various devices (e.g., a communication device 105, a server 110) of the system 100 are described as performing a number of the operations of process flow 700, any device of the system 100 may perform the operations shown.

At 705, the server 110 (e.g., scheduling manager 112) may select a ‘worker A’ having a highest composite worker ranking (e.g., based on composite evaluation data described herein). For example, ‘worker A’ may have the highest productivity among workers included in the composite evaluation data.

At 710, the server 110 (e.g., scheduling manager 112) may offer ‘worker A’ a proposed work shift (e.g., ‘proposed work shift 1’). In some aspects, the server 110 may provide ‘worker A’ a decision duration (e.g., a temporal duration, a threshold, also referred to herein as a ‘decision time’) for responding to the proposed work shift. In some aspects, the decision duration may be the same for each worker (e.g., based on a default decision duration, a minimum decision duration, etc.). In some other aspects, the server 110 may modify (e.g., increase, decrease) the decision duration based on the composite worker ranking associated with a worker. In some cases, the server 110 may modify (e.g., decrease) the decision duration based on a current time compared to a target deadline (e.g., a scheduling end time ‘E’ to be described herein) for completing the scheduling process.

At 715, ‘worker A’ may accept the proposed work shift within the decision duration (e.g., ‘yes’), and the server 110 (e.g., scheduling manager 112) may implement another iteration of the worker acceptance algorithm. For example, at 705, the server 110 may select a ‘worker B’ having the next highest composite worker ranking (e.g., the next highest productivity). At 710, the server 110 may offer ‘worker B’ a proposed work shift (e.g., ‘proposed work shift 2’).

In some examples, the server 110 may offer a proposed work shift to multiple workers at the same time. For example, at 705, the server 110 may select a ‘worker B’ and a ‘worker C’ both having the next highest composite worker ranking (e.g., the next highest productivity). At 710, the server 110 may offer ‘worker B’ and ‘worker C’ the same proposed work shift (e.g., ‘proposed work shift 2’). In some aspects, the server 110 may indicate a decision duration associated with the proposed work shift. In an example, the server 110 may assign the proposed work shift (e.g., ‘proposed work shift 2’) to the worker who first accepts the proposed work shift (e.g., at 715) within the decision duration.

Aspects of a worker rejection algorithm associated with the process flow 700 are described herein. For example, with respect to ‘proposed work shift 1’ offered to ‘worker A,’ at 715, ‘worker A’ may reject ‘proposed work shift 1’ (e.g., ‘no’) within the decision duration. Alternatively, or additionally, at 715, the server 110 may detect that ‘worker A’ failed to respond to (e.g., failed to accept) ‘proposed work shift 1’ within the decision duration.

At 720, the server 110 (e.g., scheduling manager 112) may implement another iteration of the worker acceptance algorithm. For example, at 720, the server 110 may implement (e.g., re-run) the worker acceptance algorithm and output a ‘proposed partial schedule 2’ as described with reference to 610-b of FIG. 6. In an example, at 720, the server 110 may maintain any proposed shifts that have already been accepted by a worker and/or confirmed by the server 110.

At 725, the manager may accept, reject, or modify ‘proposed partial schedule 2’ as described with reference to 620 of FIG. 6.

At 730, the server 110 (e.g., scheduling manager 112) may save instances of worker acceptances, worker rejections, or failures of a worker to respond within a decision duration. In some aspects, the server 110 may save such instances as training data (e.g., training data 243 and/or training data 268 described with reference to FIG. 2), based on which the server 110 may propose future work schedules and/or offer shifts to workers.

Aspects of the worker rejection algorithm may support alternative shifts 717 proposed by workers. For example, at 715, if ‘worker A’ rejects ‘proposed work shift 1,’ ‘worker A’ may propose an alternative shift 717. In some aspects, alternative shift 717 may partially overlap ‘proposed work shift 1’ in time. In some other aspects, alternative shift 717 may not overlap ‘proposed work shift 1’ in time. In some cases, alternative shift 717 may be associated with the same work category (e.g., a different work task, a different workstation) as ‘proposed work shift 1.’ In some other cases, alternative shift 717 may be associated with a different work category than ‘proposed work shift 1.’

In some aspects, ‘worker A’ may provide, in the proposal of the alternative shift 717, an indication (e.g., yes, no) of whether ‘worker A’ will accept the ‘proposed work shift 1’ should the alternative shift 717 not be accepted by the manager. In some cases, the worker rejection algorithm may support enabling or disabling the proposal of alternative shifts 717. For example, if a worker rejects a proposed work shift, the worker loses that shift and cannot propose an alternative shift 717.

According to example aspects of the present disclosure, the worker acceptance algorithm and worker rejection algorithm described herein may support providing at least three scheduling possibilities to a manager for review: an originally proposed schedule (e.g., no modifications, all proposed work shifts are accepted); a revised schedule in which one or more workers who rejected a proposed work shift (or failed to respond within a decision duration) are removed from the schedule; and a revised schedule in which one or more workers have proposed an alternative shift 717.

The example aspects described herein with respect to the scheduling process of process flow 600 and process flow 700 (e.g., scheduling algorithms, acceptance algorithms, rejection algorithms) may be implemented multiple times. For example, in a first iteration of the scheduling process, the server 110 (e.g., scheduling manager 112) may implement process flow 600 and process flow 700 to assign workers to shifts of a work schedule, without assigning workers to individual workstations associated with the shifts (or time-slots included in the shifts). In a second iteration of the scheduling process (e.g., after assigning workers to shifts), the server 110 may again implement process flow 600 and process flow 700, but to assign the scheduled workers to individual workstations.

In an example, in the first iteration, the server 110 may assign ‘worker A’ and ‘worker B’ as ‘pizza experts.’ For example, in the first iteration, the server 110 may assign (e.g., lock in) ‘worker A’ and ‘worker B’ to work specific shifts (e.g., time-slots). In an example, the shifts assigned to ‘worker A’ and ‘worker B’ may at least partially overlap in time. In the second iteration, the server 110 may assign ‘worker A’ to a workstation/work task associated with kneading pizza dough, and the server 110 may assign ‘worker B’ to a workstation/work task associated with assembling pizzas.

The example algorithms and formulas may be based on the following parameters:
S—scheduling start time—the time at which the scheduling process begins;
E—scheduling end time—the drop dead time to complete the scheduling process;
G—scheduling goal time—the preferred time to complete the scheduling process;
r—response time that each worker has to respond to a shift request; and
h—estimated total hours to be scheduled.

At all times t with S≤t≤E, there is a proposed schedule P(t). In an example, the proposed schedule P(t) may include both confirmed shifts (e.g., proposed shifts accepted by a worker) and offered shifts (e.g., proposed shifts for which a response is pending and for which a response duration has not expired). The total number of hours in the confirmed and offered shifts at time t is H(t). In an example, H(t) may decrease when a worker declines a proposed shift. The worker response on offered shifts may be represented as time t+r.

The worker scheduling process (e.g., dynamic and iterative scheduling of workers) may be based on satisfying the following inequality at all times (e.g., the inequality is true at all times).

H(t)(G−S)≥h(t+r−S) (Inequality 1)

In some aspects, the worker scheduling process may include offering proposed shifts to workers and monitoring worker responses such that H(t)(G−S) is as close to being equal to h(t+r−S) as possible (e.g., within a threshold).

In an example, if the server 110 (e.g., scheduling manager 112) determines that ‘inequality 1’ is not true at any time t, the server 110 may offer a minimum quantity of additional shifts to workers (e.g., per process flow 700) until ‘inequality 1’ is true.

In some aspects, if the server 110 determines that all possible shifts have been scheduled (e.g., per process flow 700), the server 110 may re-run the algorithm associated with process flow 600 (e.g., propose a partial schedule) to propose additional shifts, and the server 110 may offer a minimum quantity of additional shifts to workers (e.g., per process flow 700) until ‘inequality 1’ is true.

An example implementation of the mathematical algorithms, formulas, and parameters associated with implementing worker scheduling (e.g., dynamic and iterative scheduling of workers) is described herein.

A store implements (e.g., via a server 110, for example, a scheduling manager 112) worker scheduling on the same day (e.g., Wednesday) each week for the whole of the following week. In an example, there is at most a one-hour shift for each day of the week (i.e., for the following week, h=7). The server 110 may initiate the scheduling process at a scheduling start time of 12 pm, with a drop dead time of 12 am (midnight) and a goal to complete scheduling by 6 pm (i.e., S=0, G=6, E=12). Each worker is provided a decision duration of one hour to respond to shift offers (i.e., r=1). In an example, the workers included in a workforce may be labeled as W₁, W₂, W₃, . . . , etc., where i<j implies that worker Wᵢ is more productive than worker Wⱼ.

At t=0, the server 110 may offer proposed shifts to workers such that the value of H(t) satisfying H(t)(G−S)≥h(t+r−S). For example, since G=6, S=0, h=7, and r=1, then 6H(t)≥7. In an example, minimizing H(t) (e.g., to an integer value), the server 110 may set H(t)=2. Accordingly, for example, the server 110 may respectively offer two proposed shifts to two workers (i.e., H(t)=2). For example, based on composite worker rankings, the server 110 may offer W₁ a first work shift (e.g., a Friday shift) associated with a demand for the worker having the highest productivity, and the server 110 may offer W₂ a second work shift (e.g., a Saturday shift) associated with a demand for the worker having the next highest productivity.

At t=0.5, W₁ accepts the first shift and W₂ rejects the second shift. Based on the rejection of the second shift, H(t) is reduced to 1. To increase H(t) back to 2, the server 110 may offer W₃ the second shift.

At t=0.7143, the ‘inequality 1’ ceases to be true. For example, H(t)=2, G−S=6, and thereby H(t)(G−S)=12. Further, h=7, t=0.7143, r=1, and S=0, and thereby h(t+r−S)=12.0001. The server 110 may identify that increasing H(t) to 3 will satisfy ‘inequality 1’ (i.e., for the inequality to be true). Accordingly, for example, the server 110 may offer W₄ a third work shift (e.g., a Sunday shift).

At t=1.4 worker W₃ accepts the second work shift. (STOP)

At t=1.5715, the inequality again ceases to be true. For example, H(t)=3, G−S=6, and thereby H(t)(G−S)=18. Further, h=7, t=1.5715, r=1, S=0, and thereby h(t+r−S)=18.0005. The server 110 may identify that increasing H(t) to 4 will satisfy ‘inequality 1’ (i.e., for the inequality to be true). Accordingly, for example, the server 110 may offer W₅ a fourth work shift (e.g., a Thursday shift).

At t=1.7143, the offer to W₄ expires (e.g., a decision duration associated with accepting the fourth work shift lapses). To maintain H(t)=4, the server 110 may offer W₆ the third work shift.

At t=2.4286, the inequality again ceases to be true. For example, H(t)=4, G−S=6, and thereby H(t)(G—S)=24. Further, h=7, t=2.4286, r=1, S=0, and thereby h(t+r−S)=24.0002. The server 110 may identify that increasing H(t) to 5 will satisfy ‘inequality 1’ (i.e., for the inequality to be true). Accordingly, for example, the server 110 may offer W₇ a fifth work shift (e.g., a Wednesday shift).

At t=2.5, worker W₅ accepts the fourth work shift.

At t=2.7, worker W₆ accepts the third work shift.

At t=3.2858, the inequality again ceases to be true. For example, H(t)=5, G−S=6, and thereby H(t)(G−S)=30. Further, h=7, t=3.2858, r=1, S=0, and thereby h(t+r−S)=30.0006. The server 110 may identify that increasing H(t) to 6 will satisfy ‘inequality 1’ (i.e., for the inequality to be true). Accordingly, for example, the server 110 may offer W₈ a sixth work shift (e.g., a Tuesday shift).

At t=3.4, worker W₇ accepts the fifth work shift.

At t=4.1429 the inequality again ceases to be true. For example, H(t)=6, G−S=6, and thereby H(t)(G−S)=36. Further, h=7, t=4.1429, r=1, S=0, and thereby h(t+r−S)=36.0003. The server 110 may identify that increasing H(t) to 7 will satisfy ‘inequality 1’ (i.e., for the inequality to be true). Accordingly, for example, the server 110 may offer W₉ a seventh work shift (e.g., a Monday shift).

At t=4.2, worker W₈ accepts the sixth work shift.

At t=4.3, worker W₉ accepts the seventh work shift.

According to the example described herein, the schedule is now complete at t=4.3 (e.g., which is 4:18 pm). Based on the example implementation of the mathematical algorithms, formulas, and parameters associated with implementing worker scheduling (e.g., dynamic and iterative scheduling of workers), the server 110 may complete the schedule well in advance of the scheduling goal time of 6 pm. Accordingly, for example, aspects of implementing worker scheduling as described herein may provide reduced overhead (e.g., reduced processing, reduced scheduling time) associated with scheduling workers to shifts of a work schedule.

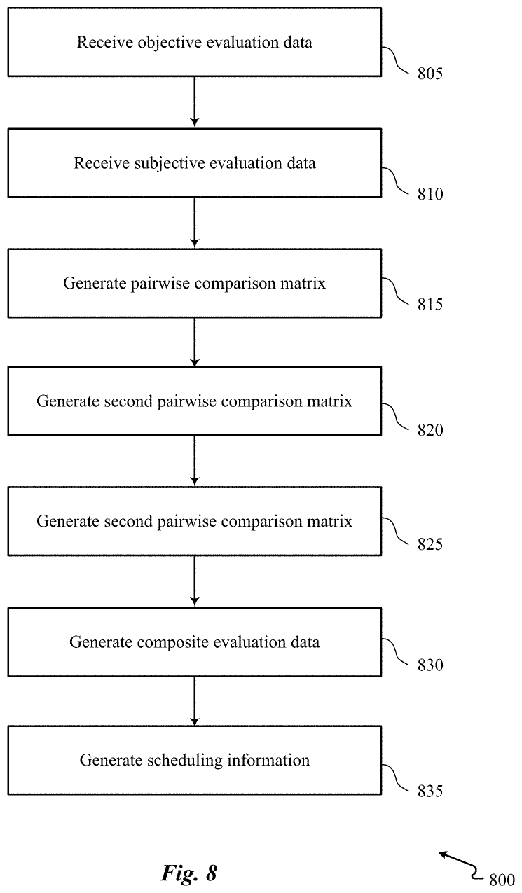

FIG. 8 illustrates an example of a process flow 800 that supports worker ranking and worker scheduling in accordance with aspects of the present disclosure.

In some examples, process flow 800 may implement aspects of system 100, system 200, or system 300 described with reference to FIGS. 1 through 3. For example, aspects of the process flow 800 may be implemented by a server 110, a server 210 (e.g., processor 250, memory 265, ranking manager 266-a, data model(s) 267, a communication device 105, a communication device 205 (e.g., processor 230, memory 240, application manager 241, data model(s) 242), or a composite worker ranker 305 described herein.

In the following description of the process flow 800, the operations may be performed in a different order than the order shown, or the operations may be performed in different orders or at different times. Certain operations may also be left out of the process flow 800, or other operations may be added to the process flow 800.

It is to be understood that while various devices (e.g., a communication device 105, a server 110) of the system 100 are described as performing a number of the operations of process flow 800, any device of the system 100 may perform the operations shown.

At 805, a server 110 (e.g., ranking manager 111) may receive objective evaluation data associated with a set of first members (e.g., workers) of a workforce.

In an example, the objective evaluation data associated with the first set of members may include: first objective evaluation data in association with a profile of a member of a second set of members of the workforce; and second objective evaluation data in association with a profile of another member of the second set of members.

In some aspects, the objective evaluation data may include performance metrics associated with performing one or more work tasks.

At 810, the server 110 may receive subjective evaluation data associated with the set of first members.

In an example, the subjective evaluation data associated with the first set of members may include: first subjective evaluation data in association with the profile of the member of the second set of members; and second subjective evaluation data in association with the other member of the second set of members.

In some aspects, the subjective evaluation data may include at least one of: subjective ratings information associated with the set of first members and one or more character attributes; qualification data associated with the set of first members and one or more types of work tasks; and subjective ratings information associated with the set of first members and one or more skill sets.

In some cases, the server 110 may receive the subjective evaluation data from the set of first members (e.g., workers), a set of second members different from the first set of members (e.g., managers), or both.

At 815, the server 110 may generate a pairwise comparison matrix associated with the objective evaluation data, the subjective evaluation data, or both. In an example, the pairwise comparison matrix may include a set of matrix entries associated with the objective evaluation data, the subjective evaluation data, or both.

At 820, the server 110 may modify (e.g., using AHP techniques described herein) one or more entries of the pairwise comparison matrix, the one or more entries including one or more unspecified entries of the set of matrix entries, one or more specified entries of the set of matrix entries, or both,

At 825, the server 110 may generate a second pairwise comparison matrix associated with evaluating a second set of members (e.g., managers).

At 830, the server 110 may generate composite evaluation data associated with the set of first members based on the objective evaluation data, the subjective evaluation data, or both, the composite evaluation data including ranking information associated with at least one member of the set of first members.

In some aspects, generating the composite evaluation data may be based on the pairwise comparison matrix. In an example, generating the composite evaluation data may be based on modifying the one or more entries (e.g., unspecified entries, specified entries) of the pairwise comparison matrix.

In some aspects, generating the composite evaluation data may include converting a first set of values included in the pairwise comparison matrix into a second set of values. In an example, values included in the first set of values are relative values, and values included in the second set of values are absolute values. In some examples, generating the composite evaluation data may include applying an analytic hierarchy process associated with converting the first set of values into the second set of values.

In some aspects, generating the composite evaluation data may be based on the second pairwise comparison matrix, a set of weighting factors respectively corresponding to the second set of members of the workforce, or both.

For example, the ranking information may include: a first ranking corresponding to the at least one member (e.g., worker) of the first set of members, and the first ranking may be generated in association with a profile of a member (e.g., a manager) of the second set of members. The ranking information may include a second ranking corresponding to the at least one member of the first set of members, and the second ranking may be generated in association with a profile of another member (e.g., another manager) of the second set of members.

In some aspects, generating the composite evaluation data may include generating a composite ranking corresponding to the at least one member of the first set of members based on respective weights associated with the first ranking and the second ranking. In an example, generating the composite evaluation data may include generating the composite ranking based on calculating a weighted geometric mean or a weighted root-mean-powers associated with the first ranking and the second ranking.

In another example, generating the composite evaluation data may include: generating first composite evaluation data based on the first objective evaluation data, the first subjective evaluation data, or both; and generating second composite evaluation data based on the second objective evaluation data, the second subjective evaluation data, or both; and combining the first composite evaluation data and the second composite evaluation data.

At 835, the server 110 may generate scheduling information associated with at least one member of the first set of members based on the composite evaluation data, the scheduling information including one or more time-slots, one or more work tasks associated with the one or more time-slots, or both.

In some aspects, generating the scheduling information may be based on satisfying an objective function in association with a set of parameters, the set of parameters including at least one of: temporal preferences associated with allocating the one or more time-slots to the set of first members; temporal parameters associated with allocating the one or more time-slots; a task type associated with the one or more time-slots; location parameters associated with allocating the one or more time-slots; and historical scheduling information associated with the set of first members.

In some other aspects, generating the scheduling information may be based on a set of parameters, the set of parameters including at least one of: a classification associated with each member of the set of first members; a first quantity corresponding to a set of workstation assignments and a temporal period. In some aspects, the workstation assignments are associated with the one or more work tasks; respective weighting factors associated with the workstation assignments; a second quantity corresponding to the set of first members. In some aspects, the second quantity may be equal to or greater than the first quantity; and qualification data associated with the set of first members and the one or more work tasks.

In some cases, generating the scheduling information may include: assigning the set of first members to the set of workstation assignments based on satisfying an equation including the set of parameters (e.g., classification associated with each member, quantity of workstation assignments).

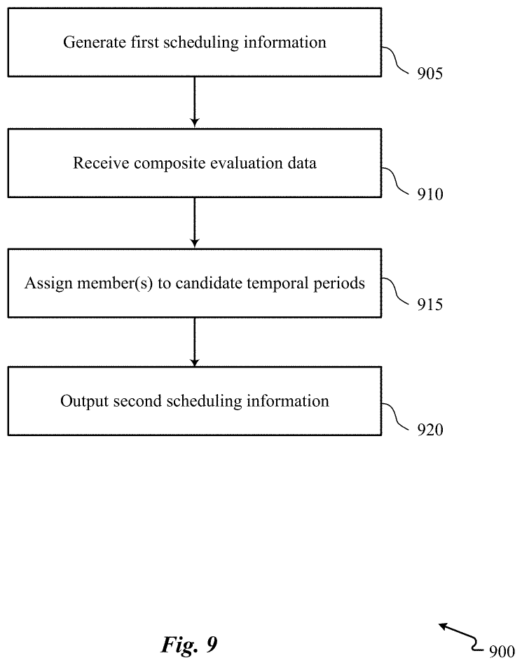

FIG. 9 illustrates an example of a process flow 900 that supports worker scheduling in accordance with aspects of the present disclosure.

In some examples, process flow 900 may implement aspects of system 100, system 200, or system 300 described with reference to FIGS. 1 through 3. For example, aspects of the process flow 900 may be implemented by a server 110, a server 210 (e.g., processor 250, memory 265, ranking manager 266-a, data model(s) 267, a communication device 105, a communication device 205 (e.g., processor 230, memory 240, application manager 241, data model(s) 242), or a composite worker ranker 305 described herein.

In the following description of the process flow 900, the operations may be performed in a different order than the order shown, or the operations may be performed in different orders or at different times. Certain operations may also be left out of the process flow 900, or other operations may be added to the process flow 900.

It is to be understood that while various devices (e.g., a communication device 105, a server 110) of the system 100 are described as performing a number of the operations of process flow 900, any device of the system 100 may perform the operations shown.

At 905, a server 110 (e.g., scheduling manager 112) may generate first scheduling information associated with a work schedule, the first scheduling information including a first set of candidate temporal periods.

At 910, the server 110 may receive composite evaluation data associated with a set of members of a workforce. In an example, the composite evaluation data may include ranking information associated with the set of members.

At 915, the server 110 may assign one or more members of the set of members to one or more candidate temporal periods of the first set of candidate temporal periods. In some aspects, the assigning may be based on a priority order corresponding to the ranking information and the set of members. In some aspects, assigning the one or more members to the one or more candidate temporal periods may include performing one or more scheduling passes.

In some aspects, assigning the one or more members to the one or more candidate temporal periods may include: providing, to a first member of the set of members, a first proposed candidate temporal period and a first temporal threshold associated with accepting the first proposed candidate temporal period. In some cases, the assigning may include providing, to a second member of the set of members, a second proposed candidate temporal period and a second temporal threshold associated with accepting the second proposed candidate temporal period.

In an example, the second proposed candidate temporal period may include at least a portion of the first proposed candidate temporal period.

In another example, providing the second proposed candidate temporal period to the second member may be based on a response by the first member or an elapsed time exceeding the first temporal threshold.

In some aspects, providing the proposed candidate temporal period to the first member may be associated with a first scheduling pass corresponding to the first scheduling information; and providing the proposed candidate temporal period to the second member may be associated with a second scheduling pass corresponding to the second scheduling information.

At 920, the server 110 may output second scheduling information based on the assigning. In some aspects, outputting the second scheduling information may be based on performing the one or more scheduling passes.

In an example, the second scheduling information may include one or more confirmed candidate temporal periods of a total quantity of candidate temporal periods associated with the work schedule. In some aspects, a quantity associated with the one or more confirmed candidate temporal periods may satisfy a quantity threshold. In an example, the quantity threshold may correspond to an elapsed time associated with assigning the one or more members to the total quantity of candidate temporal periods.

In some aspects, the server 110 may identify, from among the first set of candidate temporal periods, at least one of: a set of expired candidate temporal periods and a set of rejected candidate temporal periods. An elapsed time associated with receiving responses corresponding to the set of expired candidate temporal periods may satisfy a temporal threshold. In an example, outputting the second scheduling information may be based on identifying the set of expired proposed candidate temporal periods, the set of rejected candidate temporal periods, or both.

In some examples, the second scheduling information may include a second set of proposed candidate temporal periods. In an example, the set of second proposed candidate temporal periods may include: at least a portion of one or more expired candidate temporal periods of the set of expired candidate temporal periods; at least a portion of one or more rejected candidate temporal periods of the set of rejected candidate temporal periods; or both.

According to example aspects of the present disclosure, the server 110 may support machine learning based on responses to candidate temporal periods. For example, the server 110 may identify response information associated with the first set of candidate temporal periods and provide the response information to a machine learning network. In some examples, the response information may include at least one of: a set of responses corresponding to a first set of proposed candidate temporal periods; and an indication that an elapsed time satisfies a threshold associated with receiving responses for a second set of proposed candidate temporal periods.

The server 110 may receive an output from the machine learning network in response to the machine learning network processing at least a portion of the response information. In some aspects, outputting the second scheduling information at 920 may be based on the output from the machine learning network.

In some aspects, generating the first scheduling information at 905, assigning the one or more members to the one or more candidate temporal periods at 915, and outputting the second scheduling information at 920 may be based on a set of parameters. The set of parameters may include at least one of: a temporal instance associated with starting the scheduling process; an absolute temporal instance associated with completing the scheduling process; a target temporal duration associated with completing the scheduling process; a temporal duration associated with responding to a proposed candidate temporal period; a temporal duration associated with the work schedule; and a temporal duration corresponding to a total quantity of confirmed candidate temporal periods and a total quantity of proposed candidate temporal periods.

In some examples, assigning the one or more members to the one or more candidate temporal periods at 915, outputting the second scheduling information at 920, or both may be based on satisfying an equation including the set of parameters.

In some aspects, the server 110 may support assigning members of the workforce to work tasks after assigning all members to a candidate temporal period. For example, the server 110 may identify, from among the first set of candidate temporal periods, a set of confirmed candidate temporal periods. The server 110 may identify, from among the set of members of the workforce, a set of confirmed members assigned to the set of confirmed candidate temporal periods. In an example, the server 110 may assign the set of confirmed members to one or more work tasks associated with the set of confirmed candidate temporal periods, based on the composite evaluation data.

### Labor Sharing Platform

FIGS. 10 through 17 illustrate example aspects of an enterprise labor sharing platform in accordance with aspects of the present disclosure.

FIG. 10 illustrates an example of a labor sharing platform 1000 that supports an enterprise platform for worker ranking, worker scheduling, and labor sharing in accordance with aspects of the present disclosure. For example, the labor sharing platform 1000 may be an HCM platform that supports the sharing of worker data (e.g., skill sets, scheduling information, preference information, etc.) and/or worker demand between domains 1020 corresponding to members (e.g., enterprises, organizations) of a consortium 1005, for example, through enterprise data exchange. The labor sharing platform 1000 may support matching available workers within the consortium 1005 to worker demand (e.g., work tasks).

In some aspects, the labor sharing platform 1000 may be referred to as a social network for sharing worker capacity among members of the social network (e.g., the consortium 1005). For example, the labor sharing platform 1000 may support the identification and reallocation of workers' excess capacity (e.g., scheduling availability) to members of the consortium 1005.

In some examples, the labor sharing platform 1000 may be an example of system 100 or system 200 described with reference to FIGS. 1 and 2. In some aspects, the labor sharing platform 1000 may support enterprise labor sharing in which the consortium 1005 of members is managed by a domain 1010.

In an example, domain 1010 may be implemented by aspects of a server 110, domain 1020-a may be implemented by aspects of server 125-a, domain 1020-b may be implemented by aspects of server 125-b, and consortium 1005 may be an example of consortium 135 described with reference to FIG. 1. Alternatively, or additionally, domain 1010 may be implemented by aspects of a server 210, domain 1020-a may be implemented by aspects of server 225-a, domain 1020-b may be implemented by aspects of server 225-b, and consortium 1005 may be an example of consortium 290 described with reference to FIG. 2.

According to example aspects of the present disclosure, labor sharing platform 1000 may support onboarding multiple members (e.g., enterprises, organizations) into the consortium 1005. For example, the consortium 1005 may include any number of members, each associated with a respective domain 1020. The labor sharing platform 1000 may be managed and/or implemented by the server 110 associated with the domain 1010.

In some aspects, the labor sharing platform 1000 may support information sharing and information transfer between members of the consortium 1005 (e.g., between the domains 1020). For example, the labor sharing platform 1000 may support enterprise data exchange among the domains 1020 (e.g., via management of the labor sharing platform 1000 by the domain 1010). In some aspects, worker data for workers associated with a first member (e.g., Home Depot, associated with domain 1020-a) may be visible to a second member (e.g., Target, associated with domain 1020-b). For example, the labor sharing platform 1000 may support data correlation between the first member and the second member such that worker data is visible interchangeably between members.

The members of the consortium 1005 may be referred to as enterprise customers of the labor sharing platform 1000. In some aspects, the consortium 1005 may be referred to as a network of members. In some cases, a first member of the consortium 1005 may be a first enterprise customer, and a second member of the consortium 1005 may be a second enterprise customer.

In some other cases, a third member of the consortium 1005 may be a business associated with the first enterprise customer and a first geographic location, and a fourth member of the consortium 1005 may be a business associated with the first enterprise customer and a second geographic location (e.g., different retail locations associated with the same enterprise or organization).

In another example, a fifth member of the consortium 1005 may be a business associated with the first enterprise customer and a first brand identity, and a sixth member of the consortium 1005 may be associated with the first enterprise customer and a second brand identity (e.g., different brands associated with the same enterprise or organization).

In some aspects, the labor sharing platform 1000 may support management of a global HCM (e.g., by domain 1010). In an example, the global HCM may include an HCM associated with information silos (e.g., insular management systems) of the first member, an HCM associated with information silos of the second member, an HCM associated with information silos of a third member of the consortium 1005, etc. In some aspects, any combination of members of the consortium 1005 may be engaged in a contractual relationship (e.g., through the consortium 1005) for exchanging data through the labor sharing platform 1000.

In an example, the contractual relationship may support communication by an enterprise associated with the domain 1010 and worker(s) of the members of the consortium 1005. For example, the communication may include electronic communication by a server 110 (e.g., an enterprise manager 113) to a communication device 105 (e.g., an enterprise management application 108) of a worker. In some aspects, the labor sharing platform 1000 may support notifying workers associated with members of the consortium 1005 of available work opportunities (e.g., work shifts associated with a member of the consortium 1005), changes to the consortium 1005 (e.g., the addition of new members to the consortium 1005), etc.

An example of enrolling a worker associated with a member of the consortium 1005 and communicating with the worker (e.g., notifying the worker of enrollment, notifying the worker of work opportunities, etc.) is described herein. The example is described with reference to the first member (e.g., associated with domain 1020-a) of the consortium 1005. The example described herein may be applied to any member of the consortium 1005. For example, the example aspects may be applied to the second member (e.g., associated with domain 1020-a) of the consortium 1005.

At 1025-a, the first member (e.g., associated with domain 1020-a) of the consortium 1005 may communicate (e.g., via an enterprise manager 113 and/or an enterprise management application 108) to workers about the labor sharing platform 1000.

At 1015-a, the labor sharing platform 1000 may establish or set up enterprise data exchange between the domain 1020-a and the domain 1010. In an example, a server 110 (e.g., enterprise manager 113) supporting the domain 1010 may establish the enterprise data exchange between the domain 1020-a and the domain 1010. In some aspects, enterprise data exchange may include accessing or receiving (e.g., by server 110) data sets such as worker data and/or enterprise demand data (e.g., demand for workers, for example, task data 272 described with reference to FIG. 2, also referred to herein as member demand data) associated with the members of the consortium 1005. The worker data may include, for example, worker attributes (e.g., contact information, address, etc.), worker scheduling information (e.g., past schedules, past timecards), composite worker ranking, etc. In some examples, the worker data may include aspects of (assessment data 269-a, performance data 269-b, skillset data 269-c, and/or preference data 269-d described with reference to FIG. 2. The data exchange platform may support account security, compliance, data policies, frameworks, and traceability associated with data exchanges.

At 1035-a, the server 110 (e.g., enterprise manager 113) may receive the worker data and/or enterprise demand data via the enterprise data exchange. The server 110 may store the worker data and/or enterprise demand data to partitioned data sets 1040-a. The partitioned data sets 1040-a may be stored, for example, on a database 115, a database 215, and/or a memory 265 described herein.

At 1045, the labor sharing platform 1000 may support entity resolution (also referred to herein as record linkage, data matching, etc.). Entity resolution may include the finding and identification of records in a data set that refer to the same entity (e.g., the same member of the consortium 1005) across different data sources (e.g., data files, books, websites, and databases, information silos). For example, using entity resolution, the server 110 (e.g., enterprise manager 113) may join different data sets based on entities that may or may not share a common identifier (e.g., database key, uniform resource identifier (URI), National identification number, etc.). In some cases, differences in common identifiers may be due to differences in record shape, storage location, curator style, preference, etc.

The labor sharing platform 1000 may support an identification format shared among members of the consortium 1005. For example, based on the entity resolution at 1045, the server 110 may store worker data 1050 according to the identification format. The server 110 may store the worker data 1050, for example, on a database 115, a database 215, and/or a memory 265 described herein. In some aspects, using the identification format, the labor sharing platform 1000 may support the exchange of the worker data 1050 between members of the consortium 1005, communicate with workers, etc.

In some aspects, the worker data 1050 may include scheduling availabilities, skill sets, composite worker rankings, etc. associated with a worker. In some other aspects, the worker data 1050 and/or permissions associated with the worker data 1050 may be customizable by each worker. For example, each worker may define, in the worker data 1050, a worker profile inclusive of qualifications, scheduling availabilities, preferences, etc. associated with the worker (e.g., a work resume).

In some aspects, the labor sharing platform 1000 may support establishing data provenance for sharing worker data and/or enterprise demand data between members of the consortium 1005. In some aspects, in establishing data provenance, the labor sharing platform 1000 may support providing data control to members of the consortium 1005 (and associated with workers). For example, the labor sharing platform 1000 may support member (and worker) authorization and control of how much data can be shared by the labor sharing platform 1000 with another member of the consortium 1005 (or with a worker of the other member). For example, the labor sharing platform 1000 may share or refrain from sharing any portion of the worker data 1050 in accordance with worker permissions.

In another example, the labor sharing platform 1000 may share or refrain from sharing any portion of the worker data 1050 in accordance with contractual agreements between members of the consortium 1005. For example, the first member of the consortium 1005 may be a hardware store (e.g., Home Depot), and the labor sharing platform 1000 may support conditional sharing of worker data (e.g., do not share worker data of the first member with members of the consortium 1005 that are competitor hardware stores).

In some aspects, the labor sharing platform 1000 may support the transport or exchange of the worker data 1050 between members of the consortium 1005, without storing the worker data 1050. For example, the labor sharing platform 1000 may support the direct exchange of worker data and/or enterprise demand data between members of the consortium 1005, without the worker data and/or enterprise data passing through the domain 1010.

Data provenance (also referred to as “data lineage”) may include metadata that is paired with data records detailing the origin of, changes to, and details supporting the confidence or validity of data. In some aspects, data provenance may be defined as the origins, custody, and ownership of data.

At 1055, the server 110 (e.g., enterprise manager 113, enterprise management application 108) may send an invite to a worker to set up an account with the domain 1010. For example, the server 110 may send a web-link including information associated with registering with the labor sharing platform 1000. In an example aspect of the registration process, the server 110 may provide (e.g., to a communication device 105 of the worker) a survey including a set of fields for inputting any quantity of work qualifications, skill sets, work preferences, etc. of the worker. In some aspects, based on the amount of information provided by the worker, the labor sharing platform 1000 may provide or suggest a corresponding amount of work opportunities to the worker, thereby supporting elevated work opportunities through options, control, and growth.

At 1060, the server 110 (e.g., enterprise manager 113) may determine a worker profile for the worker. In an example, the worker profile may include calculations, inferences, and/or predictions (e.g., by the enterprise manager 113) of conditions under which the worker prefers to work. The conditions, for example, may include parameters such as pay rate (e.g., hourly pay, salary), work location, commuting distance, commute time, type of work, etc. In some aspects, the server 110 may determine the worker profile based on the survey associated with the registration process.

At 1065, the server 110 may provide notifications to a worker (e.g., to a communication device 105 of the worker). In an example, the notifications may include indications of members (e.g., enterprises, organizations) associated with the worker. In some other examples, the notifications may include indications of members and/or work tasks to which the worker has been referred.

According to example aspects of the present disclosure, the server 110 (e.g., enterprise manager 113) may identify a work task associated with a first member of the consortium 1005. The server 110 may select, from among a set of workers associated with a different member (e.g., the second member) of the consortium 1005, one or more workers that may be compatible with the work task. For example, the server 110 may identify and select a worker that is compatible with the work task based on parameters associated with the work task (e.g., task type, scheduling information associated with the work task, compensation, location) and/or worker data associated with the worker (e.g., skill set information, scheduling information, preference information associated with work tasks).

In an example, the server 110 (e.g., enterprise manager 113) may transmit a notification associated with the work task to a communication device 105 of the selected worker. In some aspects, the notification may include an indication of the work task (e.g., task description, scheduling information), the parameters associated with the work task (e.g., pay rate, location information, etc.), and/or identification information associated with the first member (e.g., name, location). In some aspects, the server 110 may transmit the notification via a communications link described herein. The notification may be, for example, a text message, an e-mail message, a push notification via an enterprise management application 108, or the like.

In some aspects, the labor sharing platform 1000 may support worker matching in response to referral requests (e.g., an indication of a work task, a request for a worker capable of the work task) indicated by members of the consortium 1005. For example, a member may be unable to give a worker enough hours for a work week, and the member may want to mitigate any possibility of losing the worker to another employer due to the lack of hours. Via the labor sharing platform 1000, the member may refer the worker to another member(s) of the consortium (e.g., a direct referral). In an example, the labor sharing platform 1000 may support placement of the worker with another member on a first-come-first-serve basis. In some aspects, the labor sharing platform 1000 may support placement of the worker with another member based on best fit (e.g., based on worker preferences, worker qualifications, member preferences, scheduling parameters, etc.).

In an example, a first member of the consortium 1005 may contact a second member of the consortium 1005 (e.g., via the labor sharing platform 1000) to transmit a requests for workers. For example, a store manager associated with the first member may contact (e.g., via the labor sharing platform 1000, via the enterprise management application 108) a store manager associated with the second member regarding a request. In another example, a server 225-a (e.g., an enterprise manager 113) associated with the first member may autonomously or semi-autonomously contact a server 225-b (e.g., an enterprise manager 113) associated with the second member regarding a request.

In some aspects, the labor sharing platform 1000 may support referral recommendations from a member of the consortium 1005 to another member. For example, the platform may support worker matching in response to referral recommendations indicated by members. For example, a first member of the consortium 1005 may transmit, to other members of the consortium 1005, an indication of an available worker(s), skill set information associated with the available worker(s), scheduling information associated with the available worker(s), or the like. The labor sharing platform 1000 may support manual referral recommendations (e.g., via a manager via an enterprise management application 108), as well as autonomous or semi-autonomous referral recommendations (e.g., via an enterprise manager 113).

Aspects of the present disclosure may incorporate any combination of the worker ranking techniques and worker scheduling techniques described herein with the labor sharing platform 1000. For example, the labor sharing platform 1000 may support the application of AHP techniques for producing composite worker rankings for workers associated with members and/or non-members of the consortium 1005. In some examples, the labor sharing platform 1000 may support scheduling such workers (e.g., using iterative scheduling described herein) and assigning workers to workstations (work tasks) based on the composite worker rankings.

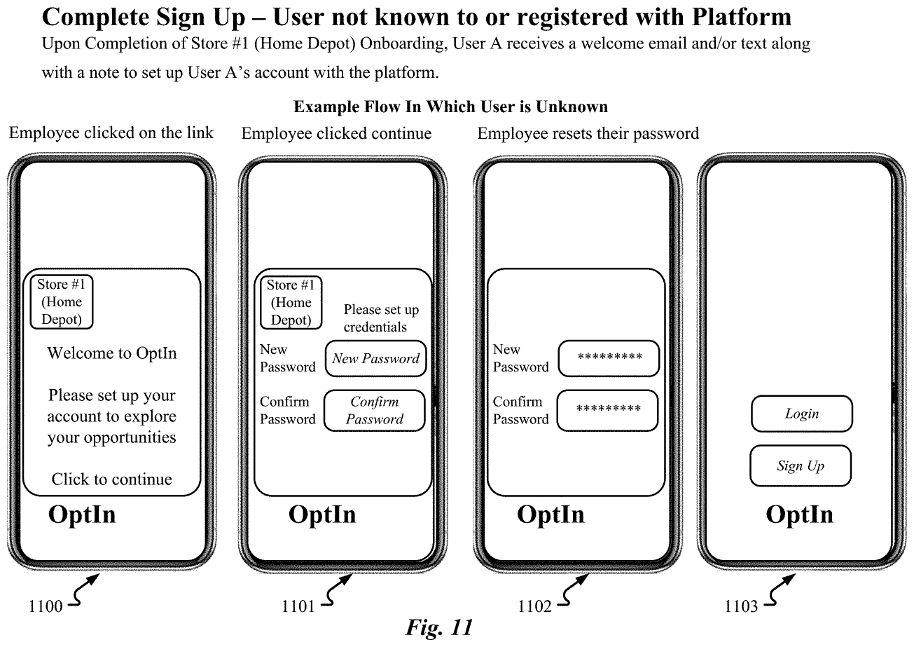

FIGS. 11 through 16 illustrate example user interfaces that support an enterprise labor sharing platform in accordance with aspects of the present disclosure. For example, FIGS. 11 through 16 illustrate example aspects of the registration process, notifications, and enterprise labor sharing described with reference to FIG. 10. Aspects of the registration process, notifications, and enterprise labor sharing may be implemented by the labor sharing platform 1000 (e.g., a server 110, an enterprise manager 113) in real-time or passively.

In some examples, the user interfaces may be implemented by a system 100, system 200, or system 300 described with reference to FIGS. 1 through 3. For example, the user interfaces may be implemented by a communication device 105 or a communication device 205 described with reference to FIGS. 1 and 2.

FIG. 11 illustrates example user interfaces 1100 through 1103 associated with a registration process of the labor sharing platform 1000.

The server 110 (e.g., enterprise manager 113) and a communication device 105 (e.g., enterprise management application 108) described with reference to FIG. 1 may implement aspects of the registration process, for example, upon completion of an onboarding process at a member of the consortium 1005 described with reference to FIG. 10. In some aspects, the onboarding process may be reviewed and completed by an administrator associated with the member.

In an example, for a worker who is unknown to (e.g., not registered with) the labor sharing platform 1000, the server 110 may transmit a communication (e.g., a welcome email or text message) to the communication device 105 of the worker. In some aspects, the labor sharing platform 1000 may implement entity resolution (e.g., entity resolution 1045 described with reference to FIG. 10) to ensure that the worker is not previously registered (not previously known to the labor sharing platform 1000).

In an example, the communication may include a text-based notification or e-mail notification to set up an account with the labor sharing platform 1000. In an example, during the registration process, the worker may be prompted to create a password (or reset a default password) and complete the login process. In some aspects, the registration process may be implemented by enterprise data load.

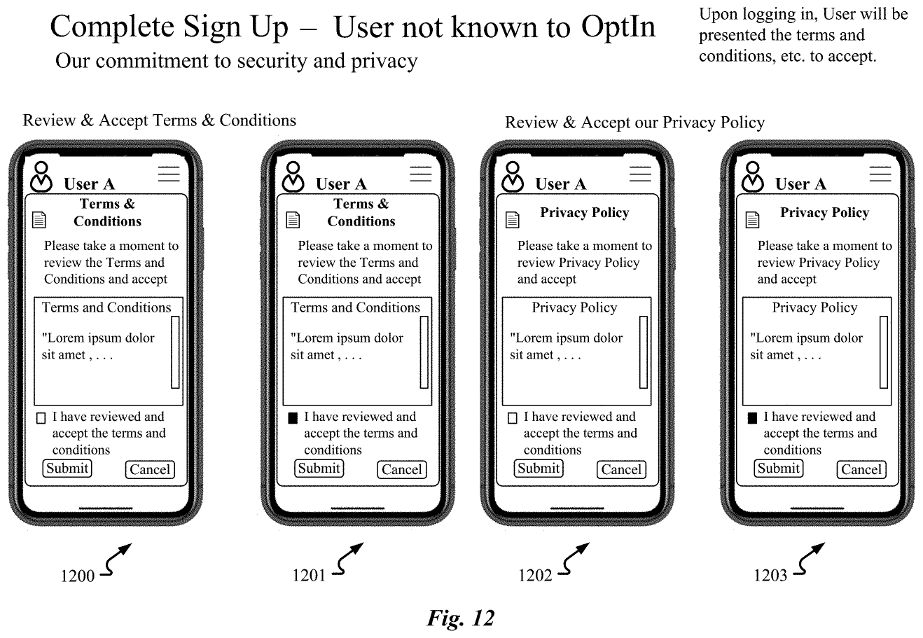

FIG. 12 illustrates example user interfaces 1200 through 1203 associated with the registration process of the labor sharing platform 1000.

For example, as part of the registration process and upon a first instance of a user log-in to the labor sharing platform 1000, the communication device 105 may display user interfaces 1200 and 1201 (e.g., terms and conditions of use to accept) and user interfaces 1202 and 1203 (e.g., privacy policies to accept).

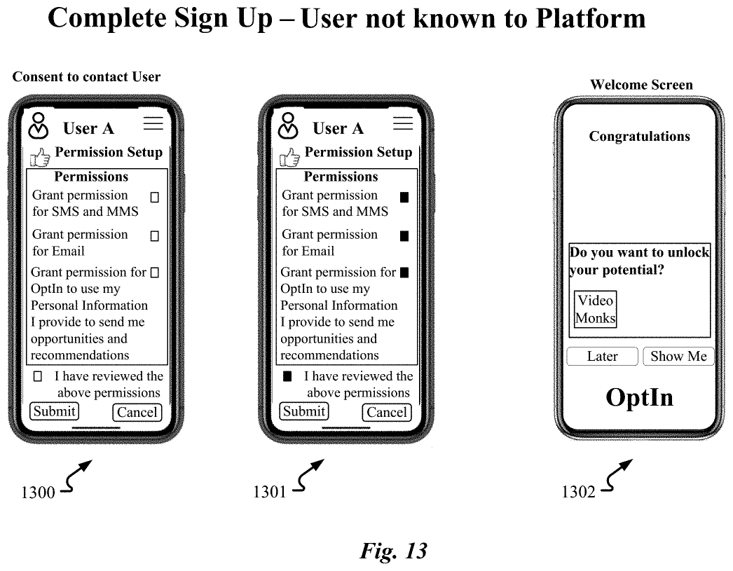

FIG. 13 illustrates example user interfaces 1300 through 1302 associated with the registration process of the labor sharing platform 1000.

For example, as part of the registration process and the first instance of a user log-in to the labor sharing platform 1000, the communication device 105 may display user interfaces 1300 and 1301 for completing the registration process (e.g., permissions to configure and submit).

In an example, based on completion of the registration process, the communication device 105 may display a welcome screen (e.g., user interface 1302).

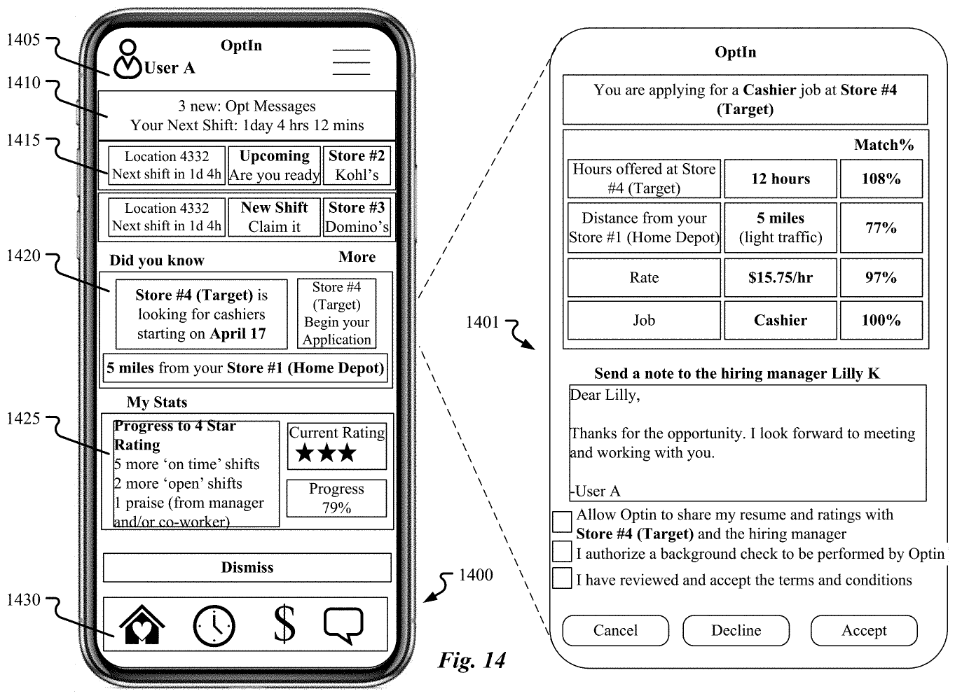

FIG. 14 illustrates an example of displaying home page information associated with the labor sharing platform 1000. For example, the communication device 105 may be associated with a worker and may display a user interface 1400 (e.g., a home page, a dashboard).

The user interface 1400 (e.g., home page) may include a notification bar 1405. In an example, the notification bar 1405 may include an indication of new messages and/or scheduling information associated with the next upcoming work shift (e.g., a scheduled work shift) for the worker.

In an example, the user interface 1400 may include notification 1410 associated with the next upcoming work shift for a worker. The communication device 105 may display information associated with the next upcoming work shift, for example, based on a user input selecting the notification 1410.

The user interface 1400 may include notification 1415 including an available work shift for a consortium member (e.g., an enterprise, an organization) with which the worker has already established a contractual work agreement. The communication device 105 may display information associated with the available work shift, for example, based on a user input selecting the notification 1415.

The user interface 1400 may include notification 1420 including an available work shift for a consortium member (e.g., an enterprise, an organization) with which the worker has not established a contractual work agreement. The communication device 105 may display a user interface 1401 associated with the available work shift, for example, based on a user input selecting the notification 1420.

The user interface 1400 may include a status notification 1425 including worker statistics (e.g., ratings) associated with previously completed work shifts. The communication device 105 may display information associated with the worker statistics, for example, based on a user input selecting the virtual button 1425.

The user interface 1400 may include a menu 1430 associated with the labor sharing platform 1000. In an example, the menu 1430 may include favorited members (e.g., enterprises, organizations), scheduling information (e.g., worked hours, upcoming work shifts, etc.), financial information (e.g., paychecks), and messaging information (e.g., access to a messaging application associated with the labor sharing platform 1000).

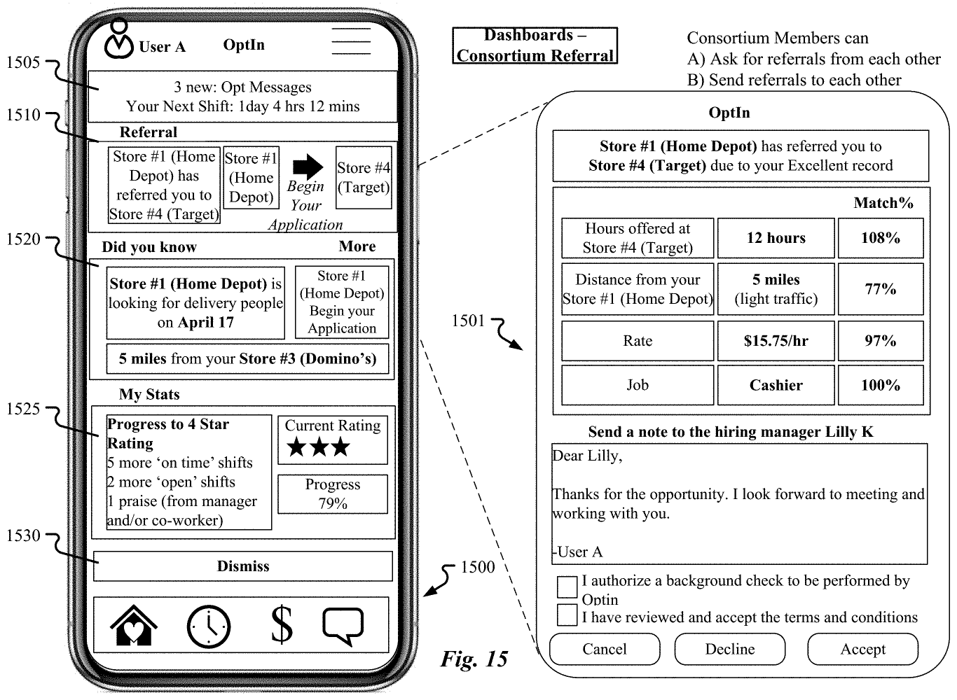

FIG. 15 illustrates an example of displaying referral information associated with the labor sharing platform 1000. User interface 1500 includes example aspects of the user interface 1400 (e.g., a home page, a dashboard) described with reference to FIG. 14.

The user interface 1500 may include notifications 1505 through 1525 and menu 1530. Notification 1505, notification 1520, notification 1525, and menu 1530 include example aspects of like elements described with reference to FIG. 14.

The user interface 1500 may include a referral notification 1510 including referral information associated with a member (e.g., enterprise, organizations) of the consortium 1005. The communication device 105 may display a user interface 1501 associated with the referral information, for example, based on a user input selecting the notification 1510.

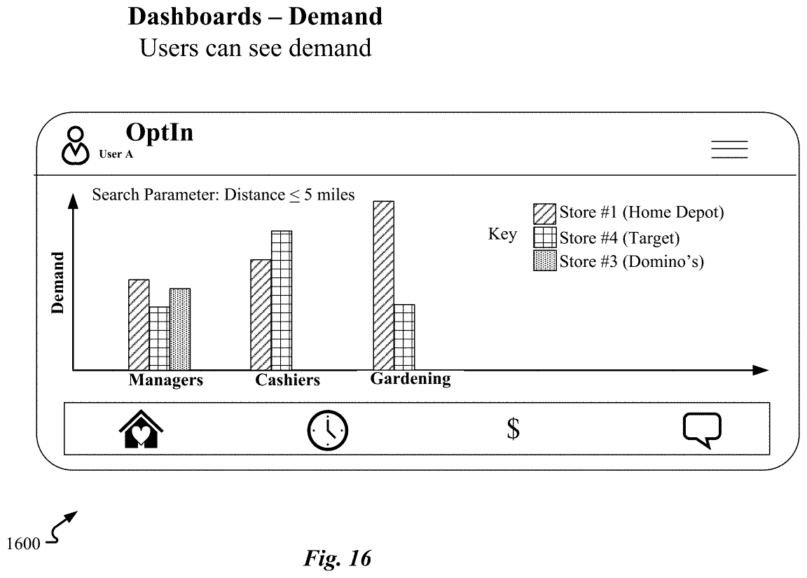

FIG. 16 illustrates an example of displaying enterprise demand data associated with the labor sharing platform 1000. In an example, the labor sharing platform 1000 may support aggregating available work tasks associated with members (e.g., Home Depot, Target) of the consortium 1005 and/or non-members (e.g., Dominos) of the consortium 1005. A communication device 105 (e.g., via enterprise management application 108) of a worker may display a user interface 1600 (e.g., a demand dashboard) based on the enterprise demand data.

The user interface 1600 may include, for example, location information and/or member (e.g., enterprise, organization) identification information associated with the available work tasks. In some aspects, the user interface 1600 may include categories (e.g., such as managers, cashiers, gardening) associated with the available work tasks. In some examples, the user interface 1600 may include a demand level associated with each of the categories.

The user interface 1600 may be customizable based on user preferences and/or user settings. For example, the user interface 1600 may be implemented as a heat map, a bar graph, a table, or the like.

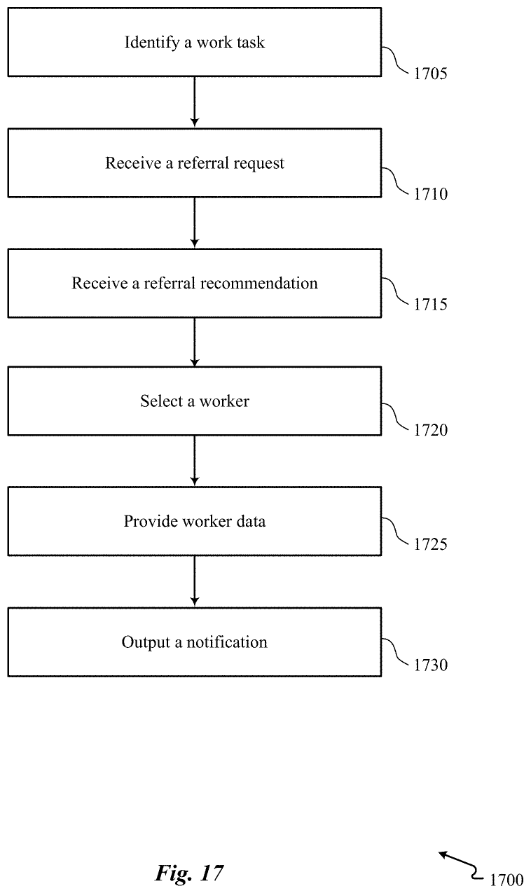

FIG. 17 illustrates an example of a process flow 1700 that supports labor sharing in accordance with aspects of the present disclosure.

In some examples, process flow 1700 may implement aspects of system 100, system 200, or system 300 described with reference to FIGS. 1 through 3. For example, aspects of the process flow 1700 may be implemented by a server 110, a server 210 (e.g., processor 250, memory 265, ranking manager 266-a, data model(s) 267, a communication device 105, a communication device 205 (e.g., processor 230, memory 240, application manager 241, data model(s) 242), or a composite worker ranker 305 described herein.

In the following description of the process flow 1700, the operations may be performed in a different order than the order shown, or the operations may be performed in different orders or at different times. Certain operations may also be left out of the process flow 1700, or other operations may be added to the process flow 1700.

It is to be understood that while various devices (e.g., a communication device 105, a server 110) of the system 100 are described as performing a number of the operations of process flow 1700, any device of the system 100 may perform the operations shown.

At 1705, the server 110 (e.g., scheduling manager 112) may identify a work task associated with a first member of a network.

At 1710, the server 110 may receive a referral request from the first member, the referral request including an indication of the work task.

At 1715, the server 110 may receive, from a second member of the network, a referral recommendation associated with the worker,

In some aspects, the referral recommendation may be based on amount of scheduled work hours associated with the worker failing to satisfy a threshold.

In an example, the first member may include a first enterprise customer included in the network; and the second member may include a second enterprise customer included in the network. In another example, the first member may be associated with the first enterprise customer included in the network and a first geographic location; and the second member may be associated with the first enterprise customer and a second geographic location. In some other examples, the first member may be associated with the first enterprise customer included in the network and a first brand identity; and the second member may be associated with the first enterprise customer and a second brand identity.

At 1720, the server 110 may select a worker from among a set of workers associated with the second member of the network. In some aspects, selecting the worker may be based on one or more parameters associated with the work task, worker data associated with the worker, or both. In an example, the worker data may include skill set information associated with the worker, scheduling information associated with the worker, preference information associated with the worker, or a combination thereof. In some aspects, selecting the worker may be based on the referral recommendation.

At 1725, the server 110 may provide, to the first member, at least a portion of aggregated worker data corresponding to the set of workers associated with the second member, based on one or more privacy settings associated with the set of workers. For example, the server 110 may aggregate worker data corresponding to the set of workers associated with the second member. In some aspects, the portion of the aggregated worker data may include at least a portion of worker data corresponding to one or more workers of the set of workers.

In some aspects, the server 110 may assign first identification information for each worker of a set of workers associated with the first member; and assign second identification information for each worker of the set of workers associated with the second member. In an example, assigning the first identification information and the second identification information may be based on an identification format associated with the network.

At 1730, the server 110 may output a notification at a device associated with the worker. In an example, the notification may include an indication of the work task, one or more parameters associated with the work task, identification information associated with the first member, or a combination thereof.

In some aspects, the server 110 may aggregate a set of available work tasks associated with a set of members of the network, a set of non-members of the network, or both, the set of members including at least the first member and the second member. The server 110 (e.g., via an enterprise management application 108 on a communication device 105) may display a graphical indication of the set of available work tasks. In an example, the graphical indication may include at least one of: location information associated with the set of available work tasks; a set of categories associated with the set of available work tasks; a demand level associated with each category of the set of categories; and identification information corresponding to members associated with the set of available work tasks, non-members associated with the set of available work tasks, or both.

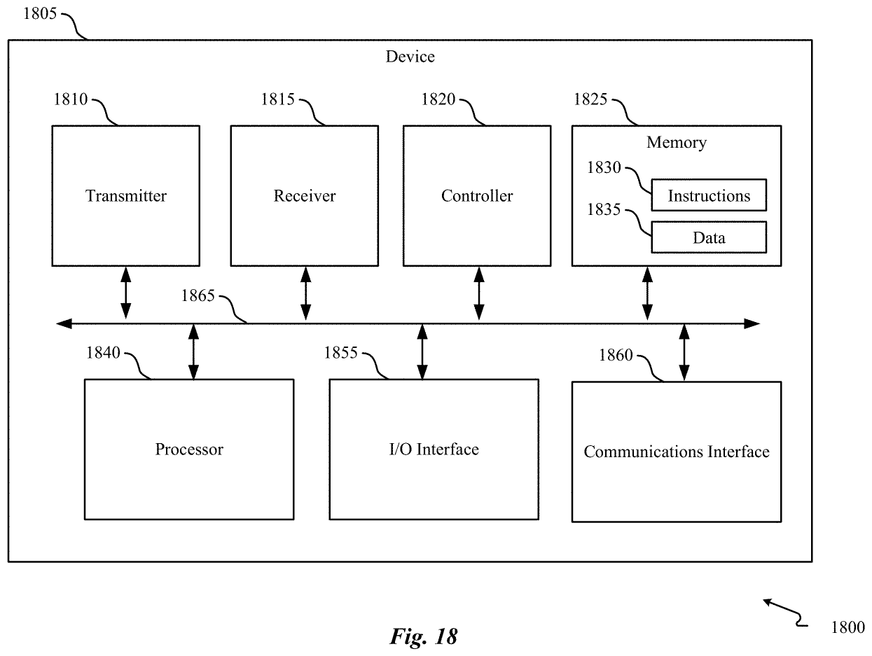

FIG. 18 illustrates an example of a system 1800 that supports an enterprise platform for worker ranking, worker scheduling, and labor sharing in accordance with aspects of the present disclosure. The system 1800 may include a device 1805. The device 1805 may include aspects of a communication device 105 or server 110 described herein with reference to FIG. 1. In some cases, the device 1805 may be referred to as a computing resource. The device 1805 may perform any or all of the operations described in the present disclosure.

In an example, the system 1800 may be used as or in conjunction with one or more of the platforms, devices, or processes described herein, and may represent components of device, the corresponding backend server(s), and/or other devices described herein. Other computer systems and/or architectures may be also used, as will be clear to those skilled in the art.

The device 1805 may include a transmitter 1810, a receiver 1815, a communications interface 1820, a controller 1820, a memory 1825, a processor 1840, and a communications interface 1860. In some examples, components of the device 1805 (e.g., transmitter 1810, receiver 1815, controller 1820, memory 1825, processor 1840, communications interface 1860, etc.) may communicate over a system bus 1865 (e.g., control busses, address busses, data busses, etc.) included in the device 1805. The components of the device 1805 may include aspects of like elements described herein.

The transmitter 1810 and the receiver 1815 may support the transmission and reception of signals to and from the device 1805. In some aspects, the transmitter 1810 and the receiver 1815 may support the transmission and reception of signals within the device 1805. The transmitter 1810 and receiver 1815 may be collectively referred to as a transceiver. An antenna may be electrically coupled to the transceiver. The device 1805 may also include (not shown) multiple transmitters 1810, multiple receivers 1815, multiple transceivers and/or multiple antennas.

The controller 1820 may be located on a same chip (e.g., ASIC chip) as the transmitter 1810 and/or the receiver 1815. In some cases, the controller 1820 may be located on a different chip as the transmitter 1810 and/or the receiver 1815. In some examples, the controller 1820 may be located on a chip of or on a chip of another device 1805. In some examples, the controller 1820 may be a programmed microprocessor or microcontroller. In some aspects, the controller 1820 may include one or more CPUs, memory, and programmable I/O peripherals.

The memory 1825 may be any electronic component capable of storing electronic information. The memory 1825 may be, for example, random access memory (RAM), read-only memory (ROM), magnetic disk storage media, optical storage media, flash memory devices in RAM, on-board memory included with the processor, EPROM memory, EEPROM memory, registers, and so forth, including combinations thereof.

The memory 1825 may include instructions 1830 (computer readable code) and data 1835 stored thereon. The instructions 1830 may be executable by the processor 1840 to implement the methods disclosed herein. In some aspects, execution of the instructions 1830 may involve one or more portions of the data 1850. In some examples, when the processor 1840 executes the instructions 1830, various portions of the instructions 1830 and/or the data 1835 may be loaded onto the processor 1840.

The memory 1825 may be, for example, a main memory of the device 1805. In some aspects, the device 1805 may include a secondary memory (not illustrated). The memory 1825 may provide storage of instructions and data for programs executing on the processor 1840, such as one or more of the functions, engines, and/or managers discussed herein. It should be understood that programs stored in the memory and executed by processor 1840 may be written and/or compiled according to any suitable language, including without limitation C/C++, MATLAB, Java, JavaScript, Pearl, Visual Basic, .NET, and the like. The memory 1825 may be, for example, a semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

In some cases, the secondary memory may include an internal memory and/or a removable medium, for example a floppy disk drive, a magnetic tape drive, a compact disc (CD) drive, a digital versatile disc (DVD) drive, other optical drive, a flash memory drive, etc. Data may be read from and/or written to the removable medium read in a well-known manner. A removable storage medium may be, for example, a physical storage medium such as a floppy disk, magnetic tape, a CD, a DVD, an SD card, etc.

The removable storage medium is a non-transitory computer-readable medium having stored thereon computer executable code (e.g., software) and/or data. The computer software or data stored on the removable storage medium may be read into the device 1805 and executed by the processor 1840.

Alternatively, or additionally, the secondary memory may include other similar means for allowing computer programs or other data or instructions to be loaded into the device 1805. Such means may include, for example, an external storage medium (not illustrated) and an interface (not illustrated). Examples of external storage medium may include an external hard disk drive, an external optical drive, or an external magneto-optical drive. Other examples of the secondary memory may include semiconductor-based memory such as programmable read-only memory (PROM), erasable programmable read-only memory (EPROM), electrically erasable read-only memory (EEPROM), or flash memory (block oriented memory similar to EEPROM).

The processor 1840 may correspond to one or multiple computer processing devices. For example, the processor 1840 may include a silicon chip, such as a Field Programmable Gate Array (FPGA), an ASIC, any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute instructions sets stored in a corresponding memory (e.g., memory 1825 of the device 1805). For example, upon executing the instruction sets stored in memory 1825, the processor 1840 may enable or perform one or more functions of the device 1805. In some examples, a combination of processors 1840 (e.g., an advanced reduced instruction set computer (RISC) machine (ARM) and a digital signal processor (DSP) 1855) may be implemented in the device 1805.

Additional processors 1840 may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with the system 1800 may include, without limitation, the Pentium® processor, Core i7® processor, and Xeon® processor, all of which are available from Intel Corporation of Santa Clara, Calif.

The I/O interface 1855 may support interactions (e.g., via a physical or virtual interface) between a user and the device 1805. The I/O interface 1855 may provide an interface between one or more components of the device 1805 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The communications interface 1860 may support the transfer of data packets (e.g., software, data) between the device 1800 and devices, networks, or information sources external to the device 1800. For example, computer software or executable code may be transferred to the device 1800 from a network server via the communications interface 1860. Examples of the communications interface 1860 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing the device 1800 with a network or another computing device.

The communications interface 1860 may implement industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data may be transferred via the communications interface 1860 in the form of electrical communication signals (e.g., via a communications channel such as a wired or wireless communications link described herein).

The system bus 1865 may include a data channel for facilitating information transfer between storage and other peripheral components of the device 1805. The system bus 1865 further may provide a set of signals used for communication with the processor 1840, including a data bus, address bus, and control bus (not shown). The system bus 1865 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Any of the steps, functions, and operations discussed herein can be performed continuously and automatically.

The exemplary systems and methods of this disclosure have been described in relation to examples of a communication device 105 and a server 110. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Example aspects of the present disclosure include:

A method including: receiving objective evaluation data associated with a set of first members of a workforce; receiving subjective evaluation data associated with the set of first members; generating composite evaluation data associated with the set of first members based on the objective evaluation data, the subjective evaluation data, or both, the composite evaluation data including ranking information associated with at least one member of the set of first members; and generating scheduling information associated with at least one member of the first set of members based on the composite evaluation data, the scheduling information including one or more time-slots, one or more work tasks associated with the one or more time-slots, or both.

Any of the aspects herein, further including: generating a pairwise comparison matrix associated with the objective evaluation data, the subjective evaluation data, or both, the pairwise comparison matrix including a set of matrix entries associated with the objective evaluation data, the subjective evaluation data, or both, wherein generating the composite evaluation data is based on the pairwise comparison matrix.

Any of the aspects herein, further including: modifying one or more entries of the pairwise comparison matrix, the one or more entries including one or more unspecified entries of the set of matrix entries, one or more specified entries of the set of matrix entries, or both, wherein generating the composite evaluation data is based on modifying the one or more entries.

Any of the aspects herein, wherein: generating the composite evaluation data includes converting a first set of values included in the pairwise comparison matrix into a second set of values, wherein values included in the first set of values are relative values, and values included in the second set of values are absolute values.

Any of the aspects herein, wherein: generating the composite evaluation data includes applying an analytic hierarchy process associated with converting the first set of values into the second set of values.

Any of the aspects herein, wherein the ranking information includes: a first ranking corresponding to the at least one member of the first set of members, wherein the first ranking is generated in association with a profile of a member of a second set of members of the workforce; and a second ranking corresponding to the at least one member of the first set of members, wherein the second ranking is generated in association with a profile of another member of the second set of members, wherein generating the composite evaluation data includes generating a composite ranking corresponding to the at least one member of the first set of members based on respective weights associated with the first ranking and the second ranking.

Any of the aspects herein, wherein generating the composite evaluation data includes: generating the composite ranking based on calculating a weighted geometric mean or a weighted root-mean-powers associated with the first ranking and the second ranking.

Any of the aspects herein, further including: generating a second pairwise comparison matrix associated with evaluating a second set of members of the workforce, wherein generating the composite evaluation data is based on the second pairwise comparison matrix, a set of weighting factors respectively corresponding to the second set of members, or both.

Any of the aspects herein, wherein: the objective evaluation data associated with the first set of members includes: first objective evaluation data in association with a profile of a member of a second set of members of the workforce; and second objective evaluation data in association with a profile of another member of the second set of members; and the subjective evaluation data associated with the first set of members includes: first subjective evaluation data in association with the profile of the member of the second set of members; and second subjective evaluation data in association with the other member of the second set of members.

Any of the aspects herein, wherein generating the composite evaluation data includes: generating first composite evaluation data based on the first objective evaluation data, the first subjective evaluation data, or both; and generating second composite evaluation data based on the second objective evaluation data, the second subjective evaluation data, or both; and combining the first composite evaluation data and the second composite evaluation data.

Any of the aspects herein, wherein generating the scheduling information is based on satisfying an objective function in association with a set of parameters, the set of parameters including at least one of: temporal preferences associated with allocating the one or more time-slots to the set of first members; temporal parameters associated with allocating the one or more time-slots; a task type associated with the one or more time-slots; location parameters associated with allocating the one or more time-slots; and historical scheduling information associated with the set of first members.

Any of the aspects herein, wherein: the objective evaluation data includes performance metrics associated with performing one or more work tasks; and the subjective evaluation data includes at least one of: subjective ratings information associated with the set of first members and one or more character attributes; qualification data associated with the set of first members and one or more types of work tasks; and subjective ratings information associated with the set of first members and one or more skill sets.

Any of the aspects herein, wherein generating the scheduling information is based on a set of parameters, the set of parameters including at least one of: a classification associated with each member of the set of first members; a first quantity corresponding to a set of workstation assignments and a temporal period, wherein the workstation assignments are associated with the one or more work tasks; respective weighting factors associated with the workstation assignments; a second quantity corresponding to the set of first members, wherein the second quantity is equal to or greater than the first quantity; and qualification data associated with the set of first members and the one or more work tasks.

Any of the aspects herein, wherein generating the scheduling information includes: assigning the set of first members to the set of workstation assignments based on satisfying an equation including the set of parameters.

A system including: a set of devices, each of the devices including: a processor; memory in electronic communication with the processor; and instructions stored in the memory, wherein the instructions are executable by the processor to: receive objective evaluation data associated with a set of first members of a workforce; receive subjective evaluation data associated with the set of first members; generate composite evaluation data associated with the set of first members based on the objective evaluation data, the subjective evaluation data, or both, the composite evaluation data including ranking information associated with at least one member of the set of first members; and generate scheduling information associated with at least one member of the first set of members based on the composite evaluation data, the scheduling information including one or more time-slots, one or more work tasks associated with the one or more time-slots, or both.

Any of the aspects herein, wherein the instructions are further executable to: generate a pairwise comparison matrix associated with the objective evaluation data, the subjective evaluation data, or both, the pairwise comparison matrix including a set of matrix entries associated with the objective evaluation data, the subjective evaluation data, or both, wherein generating the composite evaluation data is based on the pairwise comparison matrix.

Any of the aspects herein, wherein the instructions are further executable to: modify one or more entries of the pairwise comparison matrix, the one or more entries including one or more unspecified entries of the set of matrix entries, one or more specified entries of the set of matrix entries, or both, wherein generating the composite evaluation data is based on modifying the one or more entries.

Any of the aspects herein, wherein: generating the composite evaluation data includes converting a first set of values included in the pairwise comparison matrix into a second set of values, wherein values included in the first set of values are relative values, and values included in the second set of values are absolute values.

Any of the aspects herein, wherein: generating the composite evaluation data includes applying an analytic hierarchy process associated with converting the first set of values into the second set of values.

An apparatus including: a processor; memory in electronic communication with the processor; and instructions stored in the memory, the instructions being executable by the processor to: receive objective evaluation data associated with a set of first members of a workforce; receive subjective evaluation data associated with the set of first members; generate composite evaluation data associated with the set of first members based on the objective evaluation data, the subjective evaluation data, or both, the composite evaluation data including ranking information associated with at least one member of the set of first members; and generate scheduling information associated with at least one member of the first set of members based on the composite evaluation data, the scheduling information including one or more time-slots, one or more work tasks associated with the one or more time-slots, or both.

A method including: generating first scheduling information associated with a work schedule, the first scheduling information including a first set of candidate temporal periods; receiving composite evaluation data associated with a set of members of a workforce, the composite evaluation data including ranking information associated with the set of members; assigning one or more members of the set of members to one or more candidate temporal periods of the first set of candidate temporal periods, wherein the assigning is based on a priority order corresponding to the ranking information and the set of members; and outputting second scheduling information based on the assigning.

Any of the aspects herein, wherein: assigning the one or more members to the one or more candidate temporal periods includes performing one or more scheduling passes, wherein outputting the second scheduling information is based on performing the one or more scheduling passes.

Any of the aspects herein, wherein: the second scheduling information includes one or more confirmed candidate temporal periods of a total quantity of candidate temporal periods associated with the work schedule; a quantity associated with the one or more confirmed candidate temporal periods satisfies a quantity threshold; and the quantity threshold corresponds to an elapsed time associated with assigning the one or more members to the total quantity of candidate temporal periods.

Any of the aspects herein, wherein assigning the one or more members to the one or more candidate temporal periods includes at least one of: providing, to a first member of the set of members, a first proposed candidate temporal period and a first temporal threshold associated with accepting the first proposed candidate temporal period; and providing, to a second member of the set of members, a second proposed candidate temporal period and a second temporal threshold associated with accepting the second proposed candidate temporal period.

Any of the aspects herein, wherein: the second proposed candidate temporal period includes at least a portion of the first proposed candidate temporal period.

Any of the aspects herein, wherein: providing the second proposed candidate temporal period to the second member is based on a response by the first member or an elapsed time exceeding the first temporal threshold.

Any of the aspects herein, wherein: providing the proposed candidate temporal period to the first member is associated with a first scheduling pass corresponding to the first scheduling information; and providing the proposed candidate temporal period to the second member is associated with a second scheduling pass corresponding to the second scheduling information.

Any of the aspects herein, further including: identifying, from among the first set of candidate temporal periods, at least one of: a set of expired candidate temporal periods, wherein an elapsed time associated with receiving responses corresponding to the set of expired candidate temporal periods satisfies a temporal threshold; and a set of rejected candidate temporal periods; wherein outputting the second scheduling information is based on identifying the set of expired proposed candidate temporal periods, the set of rejected candidate temporal periods, or both.

Any of the aspects herein, wherein the second scheduling information includes a second set of proposed candidate temporal periods, the set of second proposed candidate temporal periods including: at least a portion of one or more expired candidate temporal periods of the set of expired candidate temporal periods; at least a portion of one or more rejected candidate temporal periods of the set of rejected candidate temporal periods; or both.

Any of the aspects herein, further including: identifying response information associated with the first set of candidate temporal periods; providing the response information to a machine learning network; and receiving an output from the machine learning network in response to the machine learning network processing at least a portion of the response information, wherein outputting the second scheduling information is based on the output from the machine learning network.

Any of the aspects herein, wherein the response information includes at least one of: a set of responses corresponding to a first set of proposed candidate temporal periods; and an indication that an elapsed time satisfies a threshold associated with receiving responses for a second set of proposed candidate temporal periods.

Any of the aspects herein, wherein: generating the first scheduling information, assigning the one or more members to the one or more candidate temporal periods, and outputting the second scheduling information are based on a set of parameters, the set of parameters including at least one of: a temporal instance associated with starting the scheduling process; an absolute temporal instance associated with completing the scheduling process; a target temporal duration associated with completing the scheduling process; a temporal duration associated with responding to a proposed candidate temporal period; a temporal duration associated with the work schedule; and a temporal duration corresponding to a total quantity of confirmed candidate temporal periods and a total quantity of proposed candidate temporal periods.

Any of the aspects herein, wherein assigning the one or more members to the one or more candidate temporal periods, outputting the second scheduling information, or both are based on satisfying an equation including the set of parameters.

Any of the aspects herein, further including: identifying, from among the first set of candidate temporal periods, a set of confirmed candidate temporal periods; identifying, from among the set of members of the workforce, a set of confirmed members assigned to the set of confirmed candidate temporal periods; and assigning the set of confirmed members to one or more work tasks associated with the set of confirmed candidate temporal periods, based on the composite evaluation data.

A system including: a set of devices, each of the devices including: a processor; memory in electronic communication with the processor; and instructions stored in the memory, wherein the instructions are executable by the processor to: generate first scheduling information associated with a work schedule, the first scheduling information including a first set of candidate temporal periods; receive composite evaluation data associated with a set of members of a workforce, the composite evaluation data including ranking information associated with the set of members; assign one or more members of the set of members to one or more candidate temporal periods of the first set of candidate temporal periods, wherein the assigning is based on a priority order corresponding to the ranking information and the set of members; and output second scheduling information based on the assigning.

Any of the aspects herein, wherein: assigning the one or more members to the one or more candidate temporal periods includes performing one or more scheduling passes, wherein outputting the second scheduling information is based on performing the one or more scheduling passes.

Any of the aspects herein, wherein: the second scheduling information includes one or more confirmed candidate temporal periods of a total quantity of candidate temporal periods associated with the work schedule; a quantity associated with the one or more confirmed candidate temporal periods satisfies a quantity threshold; and the quantity threshold corresponds to an elapsed time associated with assigning the one or more members to the total quantity of candidate temporal periods.

Any of the aspects herein, wherein assigning the one or more members to the one or more candidate temporal periods includes at least one of: providing, to a first member of the set of members, a first proposed candidate temporal period and a first temporal threshold associated with accepting the first proposed candidate temporal period; and providing, to a second member of the set of members, a second proposed candidate temporal period and a second temporal threshold associated with accepting the second proposed candidate temporal period.

Any of the aspects herein, wherein: the second proposed candidate temporal period includes at least a portion of the first proposed candidate temporal period.

An apparatus including: a processor; memory in electronic communication with the processor; and instructions stored in the memory, the instructions being executable by the processor to: generate first scheduling information associated with a work schedule, the first scheduling information including a first set of candidate temporal periods; receive composite evaluation data associated with a set of members of a workforce, the composite evaluation data including ranking information associated with the set of members; assign one or more members of the set of members to one or more candidate temporal periods of the first set of candidate temporal periods, wherein the assigning is based on a priority order corresponding to the ranking information and the set of members; and output second scheduling information based on the assigning.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/implementations in combination with any one or more other aspects/features/implementations.

Use of any one or more of the aspects or features as disclosed herein.

It is to be appreciated that any feature described herein can be claimed in combination with any other feature(s) as described herein, regardless of whether the features come from the same described implementation.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method comprising:
receiving objective evaluation data associated with a set of first members of a workforce;
receiving subjective evaluation data associated with the set of first members;
generating composite evaluation data associated with the set of first members based at least in part on the objective evaluation data, the subjective evaluation data, or both, the composite evaluation data comprising ranking information associated with at least one member of the set of first members; and
generating scheduling information associated with at least one member of the first set of members based at least in part on the composite evaluation data, the scheduling information comprising one or more time-slots, one or more work tasks associated with the one or more time-slots, or both.

2. The method of claim 1, further comprising:
generating a pairwise comparison matrix associated with the objective evaluation data, the subjective evaluation data, or both, the pairwise comparison matrix comprising a set of matrix entries associated with the objective evaluation data, the subjective evaluation data, or both,
wherein generating the composite evaluation data is based at least in part on the pairwise comparison matrix.

3. The method of claim 2, further comprising:
modifying one or more entries of the pairwise comparison matrix, the one or more entries comprising one or more unspecified entries of the set of matrix entries, one or more specified entries of the set of matrix entries, or both,
wherein generating the composite evaluation data is based at least in part on modifying the one or more entries.

4. The method of claim 2, wherein:
generating the composite evaluation data comprises converting a first set of values included in the pairwise comparison matrix into a second set of values, wherein values included in the first set of values are relative values, and values included in the second set of values are absolute values.

5. The method of claim 4, wherein:
generating the composite evaluation data comprises applying an analytic hierarchy process associated with converting the first set of values into the second set of values.

6. The method of claim 1, wherein the ranking information comprises:
a first ranking corresponding to the at least one member of the first set of members, wherein the first ranking is generated in association with a profile of a member of a second set of members of the workforce; and
a second ranking corresponding to the at least one member of the first set of members, wherein the second ranking is generated in association with a profile of another member of the second set of members,
wherein generating the composite evaluation data comprises generating a composite ranking corresponding to the at least one member of the first set of members based at least in part on respective weights associated with the first ranking and the second ranking.

7. The method of claim 6, wherein generating the composite evaluation data comprises:
generating the composite ranking based at least in part on calculating a weighted geometric mean or a weighted root-mean-powers associated with the first ranking and the second ranking.

8. The method of claim 1, further comprising:
generating a second pairwise comparison matrix associated with evaluating a second set of members of the workforce,
wherein generating the composite evaluation data is based at least in part on the second pairwise comparison matrix, a set of weighting factors respectively corresponding to the second set of members, or both.

9. The method of claim 1, wherein:
the objective evaluation data associated with the first set of members comprises:
first objective evaluation data in association with a profile of a member of a second set of members of the workforce; and
second objective evaluation data in association with a profile of another member of the second set of members; and
the subjective evaluation data associated with the first set of members comprises:
first subjective evaluation data in association with the profile of the member of the second set of members; and
second subjective evaluation data in association with the other member of the second set of members.

10. The method of claim 9, wherein generating the composite evaluation data comprises:
generating first composite evaluation data based at least in part on the first objective evaluation data, the first subjective evaluation data, or both; and
generating second composite evaluation data based at least in part on the second objective evaluation data, the second subjective evaluation data, or both; and
combining the first composite evaluation data and the second composite evaluation data.

11. The method of claim 1, wherein generating the scheduling information is based at least in part on satisfying an objective function in association with a set of parameters, the set of parameters comprising at least one of:
temporal preferences associated with allocating the one or more time-slots to the set of first members;
temporal parameters associated with allocating the one or more time-slots;
a task type associated with the one or more time-slots;
location parameters associated with allocating the one or more time-slots; and
historical scheduling information associated with the set of first members.

12. The method of claim 1, wherein:
the objective evaluation data comprises performance metrics associated with performing one or more work tasks; and
the subjective evaluation data comprises at least one of:
subjective ratings information associated with the set of first members and one or more character attributes;
qualification data associated with the set of first members and one or more types of work tasks; and
subjective ratings information associated with the set of first members and one or more skill sets.

13. The method of claim 1, wherein generating the scheduling information is based at least in part on a set of parameters, the set of parameters comprising at least one of:
a classification associated with each member of the set of first members;
a first quantity corresponding to a set of workstation assignments and a temporal period, wherein the workstation assignments are associated with the one or more work tasks;
respective weighting factors associated with the workstation assignments;
a second quantity corresponding to the set of first members, wherein the second quantity is equal to or greater than the first quantity; and
qualification data associated with the set of first members and the one or more work tasks.

14. The method of claim 13, wherein generating the scheduling information comprises:
assigning the set of first members to the set of workstation assignments based at least in part on satisfying an equation comprising the set of parameters.

15. A system comprising:
a set of devices, each of the devices comprising:
a processor;
memory in electronic communication with the processor; and
instructions stored in the memory,
wherein the instructions are executable by the processor to:
receive objective evaluation data associated with a set of first members of a workforce;
receive subjective evaluation data associated with the set of first members;
generate composite evaluation data associated with the set of first members based at least in part on the objective evaluation data, the subjective evaluation data, or both, the composite evaluation data comprising ranking information associated with at least one member of the set of first members; and
generate scheduling information associated with at least one member of the first set of members based at least in part on the composite evaluation data, the scheduling information comprising one or more time-slots, one or more work tasks associated with the one or more time-slots, or both.

16. The system of claim 15, wherein the instructions are further executable to:
generate a pairwise comparison matrix associated with the objective evaluation data, the subjective evaluation data, or both, the pairwise comparison matrix comprising a set of matrix entries associated with the objective evaluation data, the subjective evaluation data, or both,
wherein generating the composite evaluation data is based at least in part on the pairwise comparison matrix.

17. The system of claim 16, wherein the instructions are further executable to:
modify one or more entries of the pairwise comparison matrix, the one or more entries comprising one or more unspecified entries of the set of matrix entries, one or more specified entries of the set of matrix entries, or both,
wherein generating the composite evaluation data is based at least in part on modifying the one or more entries.

18. The system of claim 16, wherein:
generating the composite evaluation data comprises converting a first set of values included in the pairwise comparison matrix into a second set of values,
wherein values included in the first set of values are relative values, and values included in the second set of values are absolute values.

19. The system of claim 18, wherein:
generating the composite evaluation data comprises applying an analytic hierarchy process associated with converting the first set of values into the second set of values.

20. An apparatus comprising:
a processor;
memory in electronic communication with the processor; and
instructions stored in the memory, the instructions being executable by the processor to:
receive objective evaluation data associated with a set of first members of a workforce;
receive subjective evaluation data associated with the set of first members;
generate composite evaluation data associated with the set of first members based at least in part on the objective evaluation data, the subjective evaluation data, or both, the composite evaluation data comprising ranking information associated with at least one member of the set of first members; and
generate scheduling information associated with at least one member of the first set of members based at least in part on the composite evaluation data, the scheduling information comprising one or more time-slots, one or more work tasks associated with the one or more time-slots, or both.
